(19) United States
(12) Patent Application Publication
(10) Pub. No.: US 2014/0195184 A1
(43) Pub. Date: Jul. 10, 2014

(54) Anomaly Detection/Diagnostic Method and Anomaly Detection/Diagnostic System

(71) Applicants: Shunji Maeda, Tokyo (JP); Hisae Shibuya, Tokyo (JP)

(72) Inventors: Shunji Maeda, Tokyo (JP); Hisae Shibuya, Tokyo (JP)

(73) Assignee: Hitachi, Ltd, Chiyoda-ku, Tokyo (JP)

(21) Appl. No.: 14/239,114

(22) PCT Filed: May 30, 2012
(86) PCT No.: PCT/JP2012/063879

§ 371 Date: Feb. 14, 2014

(30) Foreign Application Priority Data
Aug. 17, 2011 (JP) 2011-178316

(51) Int. Cl. G01D 18/00; G01M 99/00

(52) U.S. Cl. CPC G01D 18/006; G01M 99/00
USPC 702/85; 702/183

(57) ABSTRACT

Provided are an anomaly detection/diagnostic method and an anomaly detection/diagnostic system whereby it is possible, in equipment such as a plant, to detect anomalies promptly and with high sensitivity, wherein anomaly detection is carried out using operating information such as the operating time of the equipment and output signals from a plurality of sensors appended to the equipment, and wherein maintenance logs such as written procedure reports comprising procedure logs and instances of past countermeasures such as replacement part information are targeted to make associations between detected anomalies and countermeasures, and create links between anomaly detection and past maintenance logs, making reference to equipment records as well, while classifying and presenting anomalies that require action, thereby improving diagnostic accuracy.

### BACKGROUND

The present invention relates to an anomaly detection/diagnostic method and an anomaly detection/diagnostic system which are used for detecting and diagnosing anomalies of a plant, equipment and the like at early times.

A power company makes use of typically waste heat of a gas turbine in order to provide a region with hot water for heating the region and provide a plant with high-pressure or low-pressure vapor. A petroleum chemistry plant operates a gas turbine or the like to serve as power-supply equipment. In this way, a variety of plants and/or various kinds of equipment each making use of a gas turbine or the like detect an anomaly thereof at an early time, diagnose a cause of the anomaly and take a countermeasure against the anomaly in order to suppress a damage inflicted on the company to a minimum. Thus, these operations are of very much importance to the company.

The turbine used as described above is not limited to the gas turbine and a vapor turbine. That is to say, the turbine used as described above may also be a water wheel employed in a hydraulic power plant, a nuclear reactor employed in a nuclear power plant, a wind mill employed in a wind power plant, an engine employed in an airplane, an engine employed in heavy equipment, a railway vehicle, railway tracks, an escalator, an elevator, medical equipment such as an MRI, a manufacturing and inspection apparatus for manufacturing and inspecting semiconductors and manufacturing and inspecting flat panel display units as well as other kinds of equipment. At the apparatus and part levels, there is also much more equipment required for detecting an anomaly such as a deterioration of an embedded battery or the life of such a battery at an early time and diagnosing a cause of the anomaly. Recently, the detection of anomalies (that is, a variety of disease states) of a human body for the purpose of health preservation is also becoming more and more important. Such anomalies are detected by typically measuring and diagnosing brain waves.

Thus, documents such as PTL 1 and PTL 2 describe sensing of an anomaly generated mainly in an engine. In accordance with the documents, past data is stored in a database (DB). First of all, the degree of similarity between observation data and the past learning data is measured by adoption of an original method. Then, linear combination of data having high degrees of similarity is used to compute inferred values. Finally, the degree of discrepancy between the inferred values and the observation data is output. PTL 3 describes typical detection proposed by General Electric as detection based on k-means clustering to sense an anomaly.

In addition, NPTL 2 and PTL 4 describe a process of acquiring useful knowledge on maintenance. In accordance with the documents, a failure history and a work history are stored in a database which can be searched for such histories in order to acquire the knowledge.

On top of that, NPTL 3 describes Gaussian processes.

### CITATION LIST

### Patent Literature

PTL 1: U.S. Pat. No. 6,952,662
PTL 2: U.S. Pat. No. 6,975,962
PTL 3: U.S. Pat. No. 6,216,066
PTL 4: Japanese Patent Application Laid-Open No. 2009-110066
PTL 5: Japanese Patent Application Laid-Open No. 2009-251822
PTL 6: Japanese Patent Application Laid-Open No. 2003-303014

### Non-Patent Literature

NPTL 1: Stephan W. Wegerich; Nonparametric modeling of vibration signal features for equipment health monitoring, Aerospace Conference, 2003. Proceedings. 2003 IEEE, Volume 7, Issue, 2003 Page (s): 3113-3121
NPTL 2: Kazutoshi Nagano and Atsushi Sato; Remote Maintenance Solutions Providing Accurate and Fast Supports (TMSTATION), Toshiba Solutions Technical News, Autumn edition 2008, Vol. 15
NPTL 3: Shinsaku Ozaki, Toshikazu Wada, Shunji Maeda and Hisae Shibuya; Subjects Related to Similarity Based Modeling and Gaussian Processes in Anomaly Detection; Pattern Recognition; Media Understanding Research Group (PRMU), Image Engineering (IE), 133-138 (2011.5)

### SUMMARY

In general, there is widely used a system for monitoring observation data and comparing the data with a threshold value set in advance in order to sense an anomaly. In this case, since the threshold value is set by paying attention to, among others, the measurement-object physical quantity of the observation data, the system can be said to be an anomaly sensing system for sensing an anomaly of a design.

With this method, it is difficult to sense an anomaly not intended by a design so that such an anomaly may be overlooked. For example, the set threshold value can no longer be said to be proper due to, among others, the operating environment of the equipment, a condition change caused by the lapse of operating years, an operating condition and an effect of a part replacement.

In accordance with the techniques based on anomaly knowledge as disclosed in PTL 1 and PTL 2, on the other hand, learning data is used as an object and linear combination of data having high degrees of similarity between observation data and the learning data is used to compute inferred values before the degree of discrepancy between the inferred values and the observation data is output. Thus, depending on the preparation of the learning data, it is possible to consider, among others, the operating environment of the equipment, a condition change caused by the lapse of operating years, an operation condition and an effect of a part replacement.

In accordance with the techniques disclosed in PTL 1 and PTL 2, however, the data is handled as a snapshot and data changes with the lapse of time are not taken into consideration. In addition, it is necessary to separately explain why an anomaly is included in the observation data. In the detection of an anomaly in a feature space having a little physical meaning as is the case with k-means clustering described in PTL 3, the explanation of an anomaly becomes even more difficult. If the explanation of an anomaly is difficult, the detection of the anomaly is treated as incorrect detection.

In addition, in accordance with the method described in PTL 4, there is constructed a system in which a failure history and a work history are stored in a database which can be searched for such histories in order to acquire useful knowledge on maintenance. (In accordance with PTL 4, there is constructed a system for displaying maintenance medical records). In this system, information on a failure history and a work history can be bonded to (associated with) each other through a search operation so that the information can be presented in a visible form.

In addition, in accordance with a method described in PTL 5, a failure risk of both the subject equipment and the sensor for diagnosing is taken into consideration in order to provide an overall diagnosing/maintenance plan.

On top of that, in a method described in PTL 6, a maintenance plan taking the risk and the cost into consideration is described.

However, the bonding of the anomaly detection and the maintenance-history information (that is, the association of the anomaly detection with the maintenance-history information) is not clear so that it is hard to say that the maintenance information stored in the system can be used effectively. With only a simple search function, even the bonding of the failure history and the work history themselves is not always successful. In such maintenance information, various kinds of information are generally dispersed and, in addition, there are many enumerations of ambiguous words so that the bonding is impossible unless a keyword serving as a keystone of the search operation is devised carefully. That is to say, in a method depending on only a search operation, from the detected anomaly including an anomaly sign, it is impossible to clarify, among others, a portion of the past information to be inspected in order to determine the cause of the anomaly, the handling carried out in the past for the cause of the anomaly and what should be done this time for the cause of the anomaly. Thus, even if the cause of the anomaly is diagnosed immediately at the anomaly detection stage, the phenomenon, the cause of the anomaly, the part to be replaced and the like remain unclear so that it is impossible to determine what action should be taken. As a result, in the reality of the condition, inspection carried out in the field by a skilled maintenance person is relied on.

It is thus an object of the present invention to present an anomaly detection/diagnostic method and an anomaly detection/diagnostic system which are capable of accurately diagnosing a newly generated anomaly (including an anomaly sign) by making use of maintenance-history information comprising past examples such as anomaly detection information and work-history/replacement part information which take sensing data as an object.

In addition, it is another object of the present invention to present a method for making a diagnosis result visually observable and for rotating a PDCA cycle for improving the sensitivity of the anomaly detection and improving the diagnosis precision.

In order to achieve the objects described above, in accordance with the present invention, pieces of maintenance-history information comprising past examples such as work-history/replacement part information are associated with each other in advance by frequencies of appearances of keywords. (Any specific keyword may form a pair of keywords in conjunction with another keyword placed in front of the specific keyword or behind the specific keyword. In such a case, the pair of keywords is referred to as a compound keyword). Then, on the basis of anomaly detection taking signals output by a multi-dimensional sensor added to the equipment as an object, the detected anomaly and the associated maintenance-history information are combined with each other so that, at a point of time an anomaly sign is detected, it is possible to provide relationships with countermeasures such as part replacements, adjustments and resumption. In this way, the diagnosis and the handling which are to be carried out for the generated anomaly can be clarified. In addition, in the case of an anomaly requiring a countermeasure, work instructions can be implemented. (In order only to see the state, the work instructions are given only to do so).

In particular, to express a condition (referred to hereafter as a context) in which maintenance-history information has been used, keywords, the linking relation between keywords and the frequency of appearance of each keyword are handled by being regarded as a context pattern. That is to say, including anomaly detection, from main keywords representing typically works related to maintenance, a context taking the actually used condition into consideration is acquired as a frequency pattern to be described later and a context-oriented anomaly diagnosis activating the context is expressed.

To put it concretely, in the anomaly detection, the precision of the diagnosis is improved by detecting an anomaly through the use of operating information such as an operating time of the equipment and signals output by a plurality of sensors attached to the equipment, by associating a detected anomaly with a countermeasure, by binding the anomaly detection to the past maintenance history (that is, by associating the anomaly detection with the past maintenance history) and by classifying anomalies each requiring an action and presenting such anomalies while referring to equipment records. In associating a detected anomaly with a countermeasure, typically, a maintenance history such as a work report comprising past countermeasure examples such as a work history and replacement part information are taken as an object.

In addition, in order to achieve the objects described above, in accordance with an anomaly detection/diagnostic method provided by the present invention to serve as a method for detecting an anomaly generated in a plant or equipment or an anomaly sign in the plant or the equipment at an early time and for diagnosing the plant or the equipment, by taking sensor data generated by a plurality of sensors mounted in the plant or the equipment and/or operating data such as operation times and operating times as an object, an anomaly of the plant or the equipment or an anomaly sign of the plant or the equipment is detected, the detected anomaly of the plant or the equipment or the detected anomaly sign of the plant or the equipment is associated with a past countermeasure by making use of maintenance-history information of the plant or the equipment and, on the basis of a result of the association, anomalies each requiring a countermeasure or anomaly signs each requiring a countermeasure are classified and presented.

In addition, the maintenance-history information includes any of on-call data, work reports, the codes of adjusted/replacement parts, video information, audio information and operating information such as operating times. The frequency of appearance of a keyword determined from the maintenance-history information and the number of linking times with other keywords and/or the linking frequency are computed in order to obtain a pattern of a high appearance frequency. The obtained pattern of the high appearance frequency is used as a category. Then, sensor data and operating data of the anomaly detected in the plant or the equipment or the anomaly sign detected in the plant or the equipment are classified and, on the basis of a result of the classification, anomalies each requiring a countermeasure or anomaly signs each requiring a countermeasure are classified and presented.

In addition, in order to achieve the objects described above, an anomaly detection/diagnostic system provided by the present invention to serve as a system for detecting an anomaly generated in a plant or equipment or an anomaly sign generated in the plant or the equipment at an early time and diagnosing the plant and the equipment is configured to comprise:
an anomaly detection section for detecting an anomaly generated in the plant or the equipment or an anomaly sign generated in the plant or the equipment by handling sensor data obtained from a plurality of sensors mounted in the plant or the equipment and/or operating data such as operation times and operating times as an object;
a database section used for storing maintenance-history information such as countermeasures for the plant or the equipment; and
a diagnosis section for associating anomalies detected by the anomaly detection section in the plant or the equipment or anomaly signs detected by the anomaly detection section in the plant or the equipment with past countermeasures by making use of information stored in the database section as the maintenance-history information of the plant or the equipment and for classifying as well as presenting anomalies each requiring a countermeasure or anomaly signs each requiring a countermeasure on the basis of results of the association.

In addition, the maintenance-history information stored in the database section includes any of on-call data, work reports, the codes of adjusted/replacement parts, video information, audio information and operating information such as operating times. A diagnostic-model generation section computes the frequency of appearance of a keyword determined from the maintenance-history information and the number of linking times with other keywords and/or the linking frequency in order to obtain a pattern of a high appearance frequency. The obtained pattern of the high appearance frequency is used as a category. Then, sensor data and operating data of the anomaly detected in the plant or the equipment or the anomaly sign detected in the plant or the equipment are classified and, on the basis of a result of the classification, anomalies each requiring a countermeasure or anomaly signs each requiring a countermeasure are classified and presented.

In accordance with the present invention, it is possible to arrange a lot of maintenance-history information existing in the field by making use of relations with anomalies. For a generated anomaly or a generated anomaly sign, it is also possible to speedily determine handling of the anomaly or the anomaly sign at a point of view for a necessary countermeasure, a necessary adjustment or the like. In addition, a proper instruction can be given to a person in charge of maintenance works. Since a condition in which the maintenance-history information is used can be accurately expressed as a context pattern or since it can be collated as a reference, the stored maintenance-history information can be reused.

In addition, a detected anomaly is associated with a past-maintenance history and, while records of the equipment are being referred to, anomalies each requiring an action are classified as well as presented. Thus, the precision of the diagnosis can be improved.

In accordance with them, early and accurate detection of an anomaly as well as a diagnosis and handling which have to be carried out become clear not only for equipment such as a gas turbine and a vapor turbine, but also for a water wheel employed in a hydraulic power plant, a nuclear reactor employed in a nuclear power plant, a wind mill employed in a wind power plant, an engine employed in an airplane, an engine employed in a heavy equipment, a railway vehicle, railway tracks, an escalator, an elevator and those at the equipment and part levels. Anomalies detected at the equipment and part levels include anomalies of various kinds of equipment and a variety of parts. Examples of such anomalies are a deterioration of an embedded battery or the life of such a battery, damages (chippings) of a drill blade used in a manufacturing process carried out to bore a hole. Diagnostic apparatus required for detecting anomalies of various kinds of equipment and a variety of parts at early times and with a high degree of precision become obvious. It is needless to say that the present invention can also be applied to measurements and diagnoses of human bodies.

### BRIEF DESCRIPTION OF DRAWINGS

FIG. 1 is a block diagram showing typical equipment serving as an object of an anomaly detection system according to the present invention, typical multi-dimensional time-series signals and typical event signals.

FIG. 2 is graphs representing signal waveforms of the typical multi-dimensional time-series signals.

FIG. 3A is a block diagram showing an example of detailed information on a maintenance history.

FIG. 3B is a block diagram showing an example of relations between a phenomenon, a cause and handling.

FIG. 4A shows an exemplary embodiment of the present invention and a typical flow of processing in which pieces of maintenance-history information comprising past examples such as work-history/replacement part information are associated with each other in advance by a keyword base and, then, on the basis of anomaly detection taking signals output by a multi-dimensional sensor added to equipment as an object, an anomaly is detected and the detected anomaly and the associated maintenance history information are combined with each other.

FIG. 4B is a graph showing a frequency pattern of a failure phenomenon causing a valve to be replaced.

FIG. 4C is a block diagram showing a process of classifying anomaly signs detected at a learning time in accordance with phenomena and/or countermeasures.

FIG. 4D is a block diagram showing a process of classifying anomaly signs detected at an operation time in accordance with phenomena and/or countermeasures.

FIG. 4E is a joint histogram acquired to serve as graphs representing countermeasures taken against anomaly phenomena in a decreasing-frequency order starting with a countermeasure having the highest frequency.

FIG. 5 is a typical table showing data for alarm generations, field inspections and handling descriptions which include a reset operation, an adjustment, a part replacement and a takeout inspection.

FIG. 6 is a typical table showing units, part numbers and part names.

FIG. 7A is a table associating phenomena with adjusted/replacement parts and showing frequencies on the basis of bonding (association).

FIG. 7B is a table associating phenomena with adjusted/replacement parts and showing frequencies on the basis of bonding.

FIG. 8A is a flowchart showing a flow of processing carried out in accordance with a method for detecting an anomaly on the basis of an example base.

FIG. 8B shows a true-false table representing the performance of detection of anomaly signs.

FIG. 9A is graphs showing cumulative values of operating times of 2 pieces of equipment.

FIG. 9B is graphs showing time cumulative values of sensor signals of 2 pieces of equipment.

FIG. 10A is graphs showing values obtained by normalizing the values by making use of an operating time to serve as time cumulative values of sensor signals.

FIG. 10B is graphs showing relations between operating-time corrected values and operating times.

FIG. 11A is a block diagram showing the configuration of an anomaly detection system according to the present invention.

FIG. 11B is a table showing typical equipment records created in the anomaly detection system according to the present invention.

FIG. 12 is a block diagram to be referred to in explanation of an example-based anomaly detection method making use of a plurality of identifiers.

FIG. 13A is a diagram to be referred to in explanation of a projection-distance method which is one of subspace classification methods serving as a typical identifier.

FIG. 13B is a diagram to be referred to in explanation of a local subspace classification method which is one of subspace classification methods serving as a typical identifier.

FIG. 13C is a diagram to be referred to in explanation of a mutual subspace classification method which is one of subspace classification methods serving as a typical identifier.

FIG. 14A is a diagram to be referred to in explanation of selection of learning data in a subspace classification method.

FIG. 14B is a graph showing a frequency distribution of distances of learning data as seen from observation data.

FIG. 15 is a table to be referred to in explanation of a variety of feature conversions.

FIG. 16 is a diagram showing a 3-dimensional space used for explaining the locus of a residual vector computed in a subspace classification method.

FIG. 17 is a block diagram showing the configuration of a processor and its peripherals in implementation of the present invention.

FIG. 18A is a block diagram showing the configuration for detecting an anomaly by processing sensor signals in a processor and by carrying out extraction/classification of features of time-series signals.

FIG. 18B is a block diagram showing the configuration of an anomaly detection/diagnostic system 100.

FIG. 19 is a diagram showing network relations between sensor signals.

FIG. 20 is a flow diagram showing details of maintenance-history information and associations of the maintenance-history information according to the present invention.

FIG. 21A is a diagram showing an external view of a drill for a hole bearing manufacturing process serving as another object of the present invention.

FIG. 21B is a block diagram showing a rough configuration of a system making use of a camera and a microphone to monitor a state in which a sample is manufactured by making use of a drill for a hole bearing manufacturing process serving as another object of the present invention.

### DESCRIPTION OF THE PREFERRED EMBODIMENTS

The present invention relates to an anomaly detection/diagnostic system for detecting an anomaly generated in a plant or equipment or an anomaly sign in the plant or the equipment at an early time. In a process of detecting an anomaly, all but normal learning data is generated and the anomaly measure of observation data is computed by adoption of a subspace classification method or the like. Then, an anomaly is determined and the type of the anomaly is identified. Subsequently, the time at which the anomaly has been generated is estimated.

In addition, in a process of associating pieces of maintenance-history information with each other, a compound keyword of a set of documents describing the maintenance-history information and the like is extracted and the compound keyword is associated with the anomaly through image classification or the like.

Then, a diagnosis model expressing the association of the compound keyword with the anomaly as a frequency pattern is generated. The diagnosis model is used for clarifying a diagnosis and handling which are to be carried out for the detected anomaly or the detected anomaly sign.

The following description explains an exemplary embodiment of the present invention by referring to diagrams.

### Exemplary Embodiment

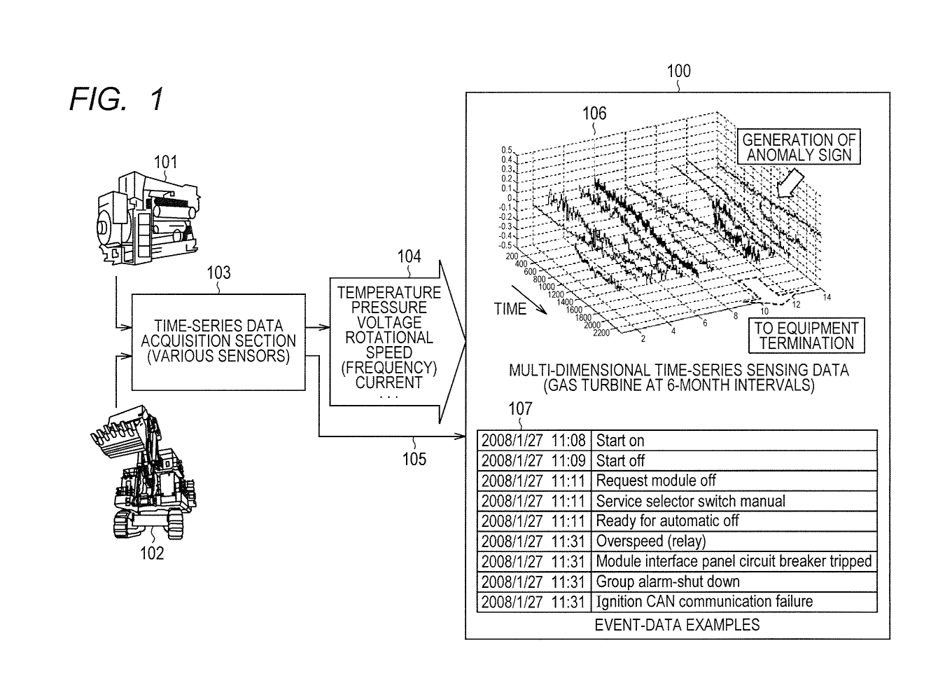

FIG. 1 shows an entire configuration including an anomaly detection/diagnostic system 100 according to the present invention. In the following description, the technical term ‘anomaly’ is used to imply not only an anomaly, but also an anomaly sign. In the figure, reference numerals 101 and 102 each denote a piece of equipment serving as an object of the anomaly detection/diagnostic system 100 according to the present invention. The pieces of equipment 101 and 102 are provided with a multi-dimensional time-series signal acquisition section 103 configured to include a variety of sensors. The multi-dimensional time-series signal acquisition section 103 generates sensor signals 104 as well as event signals 105 serving as alarm signals and signals indicating the on/off status of power supplies, supplying and processing the sensor signals 104 and the event signals 105 to the anomaly detection/diagnostic system 100 according to the present invention. The anomaly detection/diagnostic system 100 according to the present invention acquires multi-dimensional time-series data 106 and event signals 107 from the sensor signals 104 received from the multi-dimensional time-series signal acquisition section 103, processing the multi-dimensional time-series data 106 and the event signals 107 in order to carry out anomaly detection/diagnostic processing on the pieces of equipment 101 and 102. The number of types of the sensor signals 104 acquired by the multi-dimensional time-series signal acquisition section 103 is a number in a range of several tens to several hundreds of thousands. Depending on factors such as the sizes of the pieces of equipment 101 and 102 as well as damages which are inflicted on society when either of the pieces of equipment 101 and 102 fails, a variety of costs are taken into consideration in order to determine the types of the sensor signal 104 acquired by the multi-dimensional time-series signal acquisition section 103.

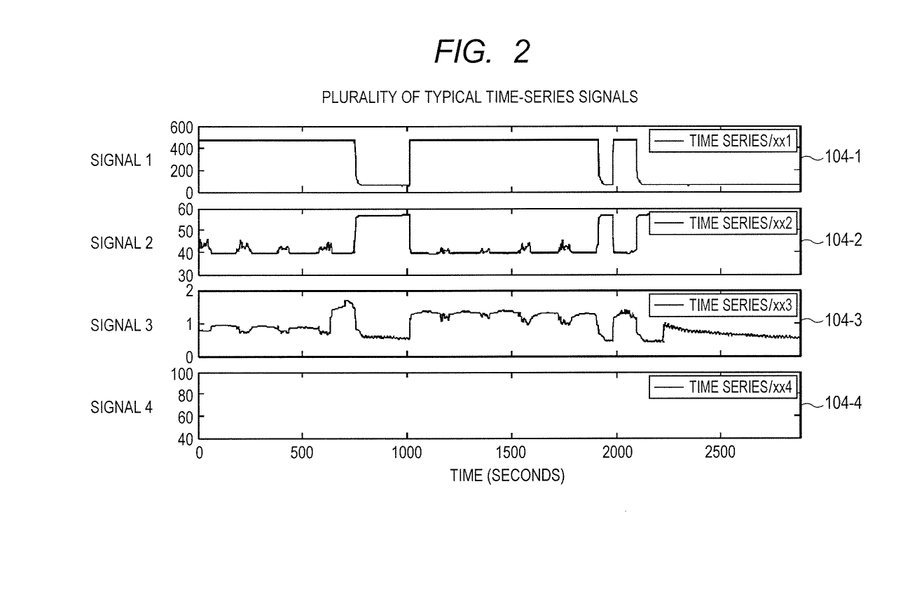

The object handled by the anomaly detection/diagnostic system 100 is the multi-dimensional time-series sensor signals 104 acquired by the multi-dimensional time-series signal acquisition section 103. The sensor signals 104 include signals representing a generator voltage, an exhausted-gas temperature, a cooling-water temperature, a cooling-water pressure and an operating-time length. The type of the installation environment is also monitored. The interval of timings to sample the sensors is a time period in a range of about several tens of ms (milliseconds) to about several tens of seconds. That is to say, there is a variety of such Intervals. The sensor signals 104 and the event data 105 include the operation states of the pieces of equipment 101 and 102, information on a failure and information on maintenance of them. FIG. 2 shows sensor signals 104-1 to 104-4 appearing along the time axis serving as the horizontal axis of the figure.

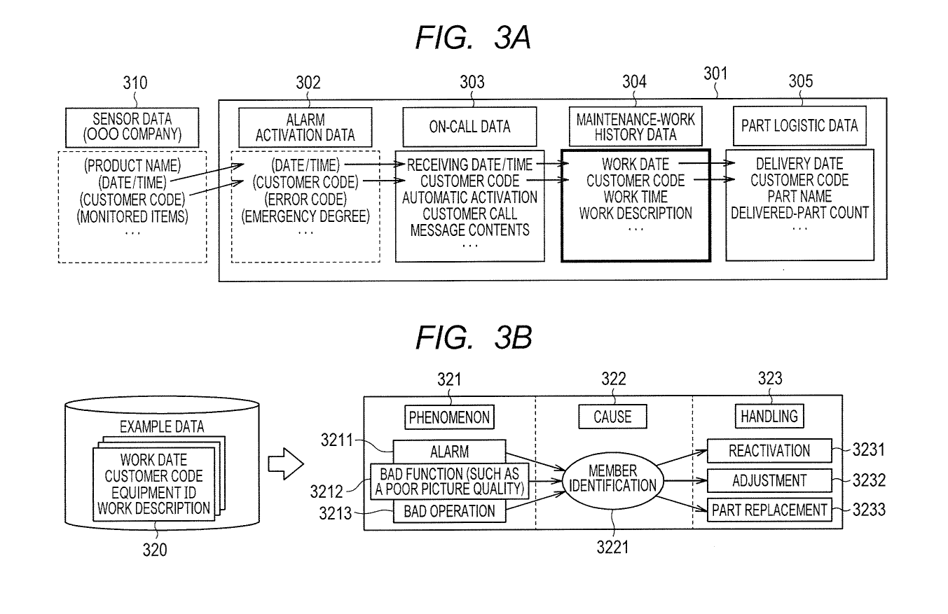

FIG. 3A shows details 301 of the maintenance-history information of the anomaly detection/diagnostic system 100. As shown in the figure, when sensor data 310 is received, alarm activation information 302, on-call data 303, maintenance work history data 304 and part logistics data 305 are associated with the maintenance-history information. The on-call data 303 shown in FIG. 3A means telephone contact data. These pieces of information are stored in a database (DB) which is denoted by reference numeral 121 in FIG. 17.

Arrows shown in FIG. 3A indicate that the pieces of information are linked from the upstream side to the downstream side. These arrows can also be oriented from the downstream side. In this case, the means that can be adopted is referred to as a search operation based on a keyword. Although the search operation is effective means, it is necessary to construct the data to be searched into the structure of a database (DB), that can be searched, in advance. In addition, some devices are required in determination of a keyword. Flexibilities are also required to absorb vertical relations of members and vertical relations of phenomena. Since the search operation is simple collation, however, this means can be adopted with ease.

FIG. 3B is a diagram showing associations of the maintenance-history information. The figure shows keywords of works such as a phenomenon 321, a cause 322 and handling 323 which are to be searched from example data 320 stored in the database (DB) denoted by reference numeral 121 in FIG. 17. The phenomenon 321 is further classified into detailed categories including alarms 3211, bad functions (such as poor picture qualities) 3212 and bad operations 3213. The cause 322 corresponds to only failing-member identification 3221. The handling 323 comprises an item 3231 representing an anomaly that can be eliminated by restarting (even though the anomaly is not completely corrected), an item 3232 representing an anomaly requiring adjustment and an item 3233 representing an anomaly requiring replacement of a part. FIG. 3B also makes use of arrows to indicate relations.

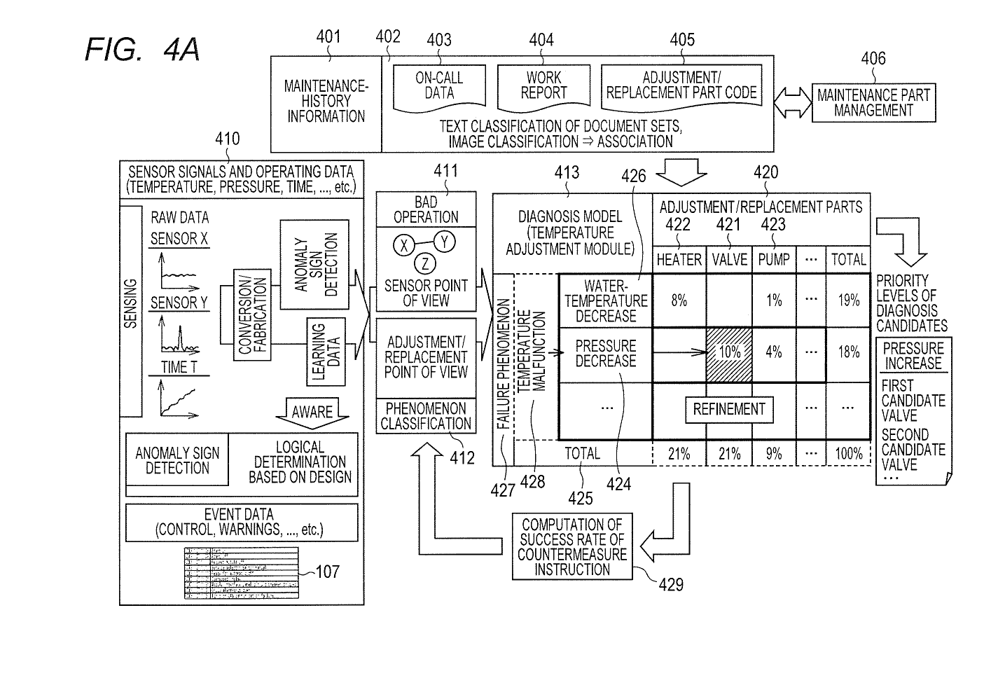

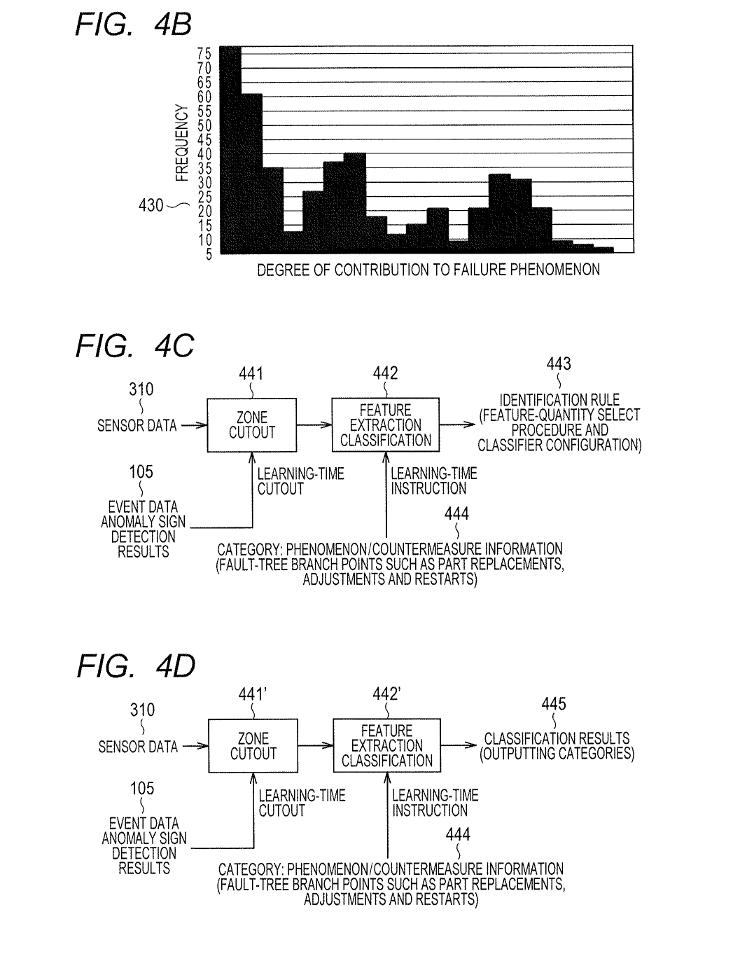

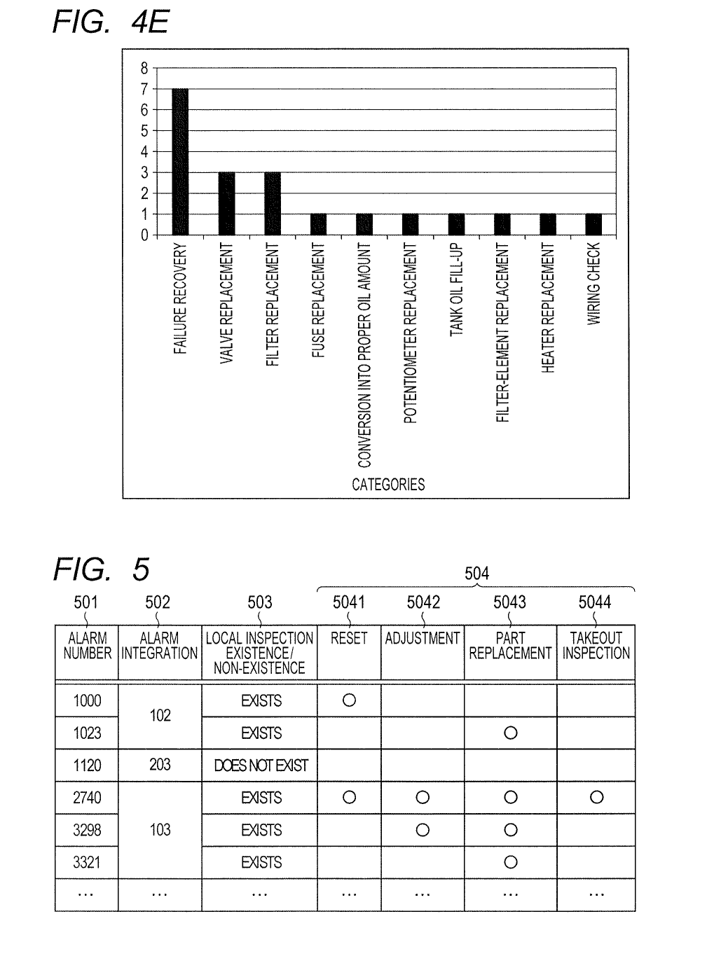

FIGS. 4A to 4E show an exemplary embodiment of the anomaly detection/diagnostic system 100 according to the present invention.

To be more specific, FIG. 4A shows an example of a mechanism in which pieces of maintenance-history information comprising past examples such as work-history/replacement part information are associated with each other in advance by a keyword base and, then, on the basis of anomaly detection taking signals output by a multi-dimensional sensor added to the equipment as an object, an anomaly is detected and the detected anomaly and the associated maintenance history information are combined with each other, the success rate of the result of the combination is evaluated and the precision of the diagnosis is improved. Since maintenance-history information is used and a stored condition (context) is expressed, the frequency of appearance of a keyword is handled by being regarded as a context pattern.

As an example in which the relations between keywords and their appearance frequencies are treated by regarding the relations and the frequencies as a context pattern, the following description explains a method of adopting the concept of a bag of words. The concept of a bag of words is a technique which should also be referred to as a bag of features. In accordance with this concept, information (features) are handled by ignoring the generation order of the information and its positional relations. In this technique, from alarm activation information, work reports, the codes of replacement parts and the like, the frequencies of generations of keywords, codes and words as well as a histogram are created. The distribution form of this histogram is regarded as a feature for classification into categories.

This method is characterized in that, unlike the one-to-one search like the one described in NPTL 2, a plurality of pieces of information can be handled at the same time. In addition, this method can also be used to handle free descriptions so that this method can also be used with ease to handle changes such as additions and deletions of information. On top of that, this method is also effective for changing the format of a work report or the like. Even if a plurality of treatment is carried out or even if an incorrect treatment is included, since attention is paid to the distribution form of the histogram, the robustness is high. In the same way, sensor signals are also classified into a plurality of categories. These categories are keywords.

It is to be noted that, for the order of a plurality of keywords, let the connectivity be taken into consideration in advance. That is to say, for a text sentence in an ordinary morpheme analysis, the sentence is divided into single words and only nouns are extracted. Then, the number of types of words preceding and succeeding each of the single words is counted. Let the number of types of words preceding a single word be WL whereas the number of types of words succeeding a single word be WR. In this case, the expression (WL+1)×(WR+1) is considered to be the importance of the single word. The importance of a compound word is obtained by multiplying the product of the importance values of single words composing the compound word by (1/single-word count) to give a result and multiplying the result by the frequency of appearance of the compound word. Thus, it is possible to set an order by making use of the importance of each keyword. In a maintenance-history sentence, an example of the countermeasure can be extracted by combination with a symptom of equipment.

For example, as a phenomenon, a sentence was written as follows: ‘10/12 was activated and the temperature of exhausted gas of the tenth cylinder decreased while the temperature of exhausted gas of the first cylinder increased in the course of an operation’. As a countermeasure, a sentence was written as follows: ‘Since water was injected into the OO section, the □□ part of the ΔΔ section was replaced’. In this case, the single words ‘exhausted’ and ‘temperature’ serve as an important compound word. In a maintenance-history sentence, their generation frequencies are also taken into consideration and linked to the compound word ‘part replacement’.

Such an expression represents a condition in which maintenance has been carried out and is also referred to as a context. A context gives responses to questions including those described as follows:

In what condition was its information effective?

What was solved by making use of it?

Why was it used?

What is attention paid to?

What are relations with other information?

The context provides a tentative theory for an explanation and a base for the theory.

What expresses such a context is the compound keyword described above, its appearance frequency and their relation. Also from a sequence-characteristic point of view and a simultaneousness (co-occurrence) point of view, the relation of a compound keyword can be seen.

The example shown in FIG. 4A is a typical association established by paying attention to the frequency. An example of part replacement is explained as follows. In FIG. 4A, from the inside of maintenance-history information 401 (corresponding to example data 320 shown in FIG. 3B), a record 405 (corresponding to part replacement 3233 shown in FIG. 3B) of a replacement part is automatically accessed as details 402 of the maintenance-history information. For example, an example of part replacement is considered as follows. This replacement-valve name (a part name), a part code (a part number), a time and the like are taken as a keyword. As information surrounding the maintenance-history information 401, a part table and the like are normally prepared. Thus, this part table is accessed and the name of a unit to which the replacement part pertains and the like are also provided with an additional keyword.

Then, a path to the replacement is accessed. In a work report 404, the path to the replacement of the part is described. What is added as a keyword includes an alarm name, a phenomenon name, verified locations included in action descriptions (resumption, adjustment and part replacement) and adjusted locations. In addition, as necessary, information on on-call data 403 is also used. If required, details 402 of the maintenance-history information are associated with information on maintenance-part management 406 and used in creation of a table 420.

The alarm name is generated by remote monitoring of the equipment. In FIG. 4A, the name of an alarm is information pertaining to sensor signal/operating data 410 shown on the left side. The name of an alarm is the name of an anomaly which can be a decrease of the water pressure, an increase of a pressure, an extremely high rotational speed, an abnormal noise, a poor picture quality or the like. The name of an alarm is also expressed by a code such as a number. If a diagnosis of a phenomenon is carried out on the remote monitoring side, a phenomenon diagnosis result implemented by reference numeral 411 is also added to the keyword. In this case, the phenomenon diagnosis result indicates whether or not there is a correlation between monitored sensor signals and indicates a phase relation between them. These are converted into a keyword or quantized (can be said to be converted into a number of a basis) to produce the phenomenon diagnosis result. The object can also be a symptom detected at an anomaly sign stage instead of a generated anomaly.

As shown in FIG. 4A, a plurality of keywords described above, that is, a code book, is summarized into a histogram with a table format 420. In the example of replacement of a valve, within the table, on a column of the replaced valve 421, the frequency of appearance increases. On a total row 425 at the bottom of the table format 420, valves occupy 21%. Parts other than the valves 421 are heaters 422 and pumps 423. If a heater 422 and a pump 423 are also replaced in addition to the valve 421, their appearance frequencies also increase. In addition, as a phenomenon diagnosis 411, a pressure decrease has been reported. Thus, in the table 420, the frequency of an intersection (a hatched portion in the table 420) of the valve 421 and the pressure decrease 424 increases.

In FIG. 4A, data is normalized and expressed in terms of percentages (%) in place of frequencies. However, it can also be expressed in terms of frequencies. If the examples of replacement of valves of the same type are summarized, a more reliable table can be generated. In this way, a diagnosis table reflecting past examples can be created. In the bag-of-words method, this frequency pattern is taken as a feature quantity. The frequency pattern of the column for valves represents frequencies for a plurality of phenomena leading ahead of the replacement of a valve.

It is to be noted that a keyword and a code book are given by the designer and a person in charge of maintenance, being stored in the maintenance-history information 401. However, urgencies and weights may also be attached to these kinds of importance. By making use of a mutual time relation between keywords as a relation showing an early or late period of time, a weight may be attached or used as a selection reference. As described earlier, for the order of a plurality of keywords, the number of types of words preceding and succeeding each of the single words is counted and the frequency is found to take connectivity and relationships into consideration. In this way, if keywords are considered as a compound keyword, in the maintenance-history sentence, by combining with a symptom of the equipment, an example of a proper countermeasure can be extracted.

Next, the following description explains a case in which an anomaly has been newly generated. In the phenomenon diagnosis 412, the type of an anomaly is determined from the sensor-signal point of view. For example, the name of the anomaly is determined to be a pressure decrease. In this case, in accordance with the diagnosis model described above, the probability of the replacement of a valve is 10%. Since this probability is known to be higher than other cases, in order to confirm that this valve is to be replaced, first of all, the diagnosis model is used in the field. It is needless to say that the sensor signals may also be analyzed in more detail in order to identify the failing member.

In this exemplary embodiment, the table 420 is further utilized. Normally, the phenomenon is complicated so that, even if the name of the anomaly is determined to be a pressure decrease, there are also conceivably many cases in which a part other than a valve is replaced. Thus, attention is paid to a frequency pattern representing a failure phenomenon 427. (In the model 420 shown in FIG. 4A, the frequency pattern is the frequencies 430 of a water-temperature decrease 426 or a pressure increase 424). (For every phenomenon, as shown in FIG. 4B, a frequency pattern 430 of a failure phenomenon leading ahead of the replacement of a valve is generated. The vertical axis represents the frequency whereas the horizontal axis represents the type of the failure phenomenon and the degree of contribution to the failure phenomenon). This frequency pattern 430 is taken as a feature quantity and, as a frequency pattern matching this feature, the frequency pattern of a valve, that is, the valve 421, is selected.

In the example shown in FIG. 4B, the horizontal axis takes the failure phenomenon leading ahead of the replacement of a valve. However, details of the countermeasure, things to be confirmed, places to be adjusted or others can be taken as items of the horizontal axis. It is to be noted that the degree of contribution to the failure phenomenon is the degree of separation from normal states of the sensor signals (denoted by reference numeral 104 in FIG. 2).

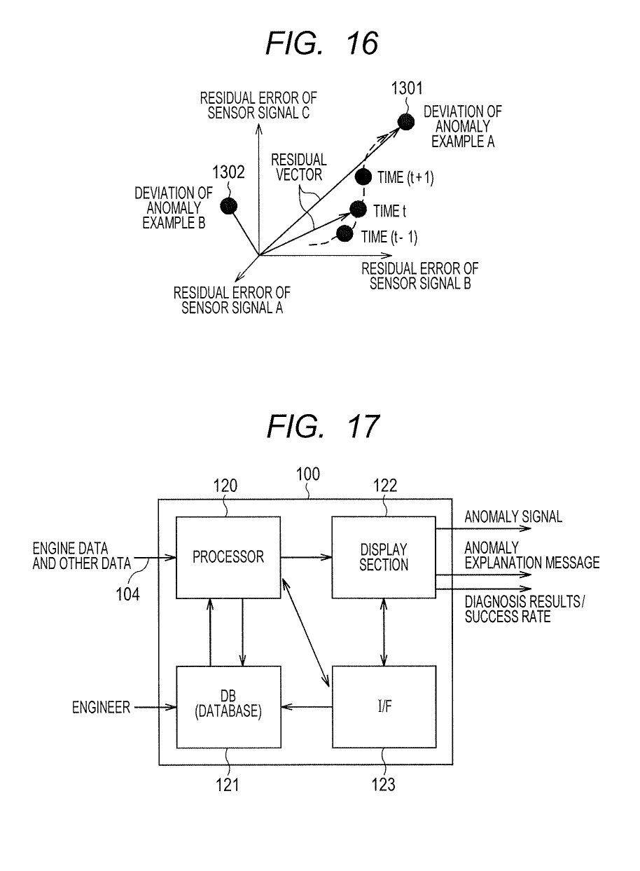

Thus, it is necessary to pay attention to the fact that, with regard to data to be observed and diagnosed, the start time of a diagnosis is a kind of pattern instead of a frequency. It is needless to say that, at the start time of a diagnosis, information can be used to serve as not only the contribution degree, but also the frequency of the contribution degree which is a time-axis summary in some cases. Attention is paid to time-series variations of a residual vector shown in FIG. 16 to be described later. If the variations are handled as a generation frequency in a fixed time window, the variations can be handled as frequency information or a frequency pattern. In either case, in the method based on the frequency pattern described above, attention is paid to the distribution form instead of carrying out simple processing of existence or non-existence. Thus, in comparison with a technique based on a simple search operation, the flexibility and the robustness of the method based on the frequency pattern described above are extremely high.

As described above, if a diagnosis model is adopted, the diagnosis work can be carried out smoothly in the field so that the time it takes to carry out the diagnosis work can be shortened substantially. In addition, a candidate for a part to be replaced can be prepared in advance so that the recovery time of the equipment can also be shortened considerably as well.

In the example described above, a frequency pattern is taken as the type of a failure phenomenon. However, any information other than a frequency pattern can be used as long as the information is usable. Examples of the usable information are a confirmed member, an adjusted member, information acquired from an on-call, a replacement part and an explained takeout anomaly cause. It is also the reason why the bag-of-words method paying attention to the frequency can also be adopted. In addition, when there are many items of the horizontal axis, the number of dimensions can also be said to be large. Thus, reducing the number of dimensions in advance is effective. The ordinary pattern recognition technique can also be said to be effectively usable. Examples of the ordinary pattern recognition technique are a principal components analysis, an independent components analysis and selection of a feature quantity. It is also possible to adopt a normalization technique such as the whitening technique.

In the anomaly detection/analysis system shown in FIG. 4A, as a classification point of view, an example of a replacement part is shown. However, there may be another classification point of view. A category of another definition can be created on the horizontal axis as a table (a diagnosis model) 420. An example of the category is an adjusted member such as a setting dial including a numerical value, a verified item of the condition, a resistance and a set time. That is to say, in accordance with the objective, the condition and the user, a plurality of diagnosis models separated from each other on a plurality of sheets are adopted. It is to be noted that a pattern statistic method other than the bag-of-words method can also be adopted.

In addition, for results of these diagnoses, it is possible to construct a mechanism for evaluating the success rate and expressing improvements of the precision of the diagnoses. Success-rate evaluation 429 of a countermeasure instruction shown in FIG. 4A is carried out for evaluating whether or not a diagnosis result actually matches. The success rate is displayed so as to improve the anomaly detection and the diagnosis in order to increase the success rate. For an anomaly sign not requiring a countermeasure, it is feared that the anomaly detection itself is over detection. Thus, in this case, for the sensitivity of anomaly detection in an ‘if then’ format for comparing a sensor signal with a threshold value for example, the threshold value is adjusted. This also applies to example-based anomaly detection. In accordance with a pattern recognition technique to be described later, however, in the event of over detection, it is also possible to indicate that these are normal data. As described above, for an anomaly requiring a countermeasure even though the countermeasure is meaningless or the effect of the countermeasure is small, since the detection of the anomaly can be visually observed, an effort can be made to improve the precision. In either case, on the basis of objective numerical values, the PDCA cycle of the anomaly detection and the PDCA cycle of the diagnosis can be carried out.

This diagnosis model can be used also as educational information for young scholars. In addition, on the basis of the diagnosis model, it can be reflected in a work procedure manual for maintenance.

In FIG. 4A, the phenomenon classification 432 is also important. In this case, the phenomenon classification is defining a keyword (a category) in advance for an anomaly detected with sensor signals 410 taken as an object at a view point of handling such as adjustment and/or replacement. The defined keyword (category) is added or corrected and used in the diagnosis model 413. To put it concretely, in accordance with a result of the phenomenon classification, the keyword (the category) is added to the generated anomaly or the generated anomaly sign. If a water-pressure increase has been detected, addition of ‘water-pressure increase’ as a keyword (a category) is a simplest case. In addition, in accordance with classification based on a determination tree such as C4.5, a keyword (a category) can be added automatically. In accordance with the phenomenon, a keyword is added. At the stage of clarifying the type of the adjustment and the type of the replacement, however, keywords (categories) are grouped or subdivided in order to add a new keyword (category). As described above, the capability of editing the phenomenon classification in this way is necessary.

The maintenance-history information 401 shown in FIG. 4A should also be referred to as an EAM for maintenance. In general, the EAM is an abbreviation of the enterprise asset management which is also called the enterprise/equipment-asset management. In this management, various kinds of information on equipment assets owned by an enterprise are managed uniformly throughout their life cycles in order to find a job improvement solution for visualization, standardization and efficiency improvement of the assets themselves and jobs related to the assets. However, what is shown in FIG. 4A is the EAM specialized for maintenance. In such maintenance EAM, in addition to written-document management such as the maintenance-history information 401, detection of an anomaly sign, diagnosis and maintenance part planning are included. It is to be noted that the maintenance part planning is planning to make inventory management of maintenance parts proper. The maintenance parts are parts used for implementing maintenance on the basis of a diagnosis result.

FIGS. 4C and 4D are block diagrams showing operations to create a recognition rule 443 or a classification result 445 by carrying out feature extraction classifications 442 and 442′ in accordance with a phenomenon enlightening an anomaly sign at a learning time by carrying out a segment cutting out processes 441 and 441′ inputting sensor data 310 and making use of event data 105 and in accordance with countermeasure information 444 (part replacement, adjustment, resumption and others).

To be more specific, FIG. 4C is a block diagram for a learning time whereas FIG. 4D is a block diagram for an operation time. The sensor data 310 is subjected to the feature extraction classifications 442 and 442′ in accordance with the phenomenon and the countermeasure information 444. Thus, an anomaly sign newly detected can be brought to a countermeasure promptly. In the classification, it is possible to make use of an ordinary identifier such as a support vector machine, a k-NN (Nearest Neighbor) or a decision tree. In the examples shown in FIGS. 4C and 4D, a segment is determined so as to include an anomaly sign. However, a segment is selected to include all anomaly sign points, ½ of anomaly sign points or ¼ of anomaly sign points.

FIG. 4E is a graph further showing countermeasures (categories) in a decreasing-frequency order starting with a countermeasure having the highest frequency by presenting a joint histogram of countermeasures for anomaly phenomena in order to represent a relation between the anomalies and the countermeasures. The vertical axis represents the frequency. In this case, a certain anomaly is taken as an example and actually executed countermeasures are shown. From such a relation, sensor data which is produced when an anomaly is generated is acquired and learned by adoption of the method shown in FIG. 4C. (That is to say, parameters of the identifiers are determined). In addition, when an anomaly sign is detected, if the sensor data is classified into categories by making use of the learning data, at the stage of the anomaly sign, a countermeasure that should be taken can be imaged. (So far, even though the type of the anomaly can be identified, a countermeasure does not come to mind).

In addition, FIG. 4E is linked to the priority levels of countermeasures even in a singularity case and displaying it is meaningful. In the example shown in the figure, countermeasures having low frequencies also exist in no small measure. They are encompassed to be meaningful for an ability to look down upon.

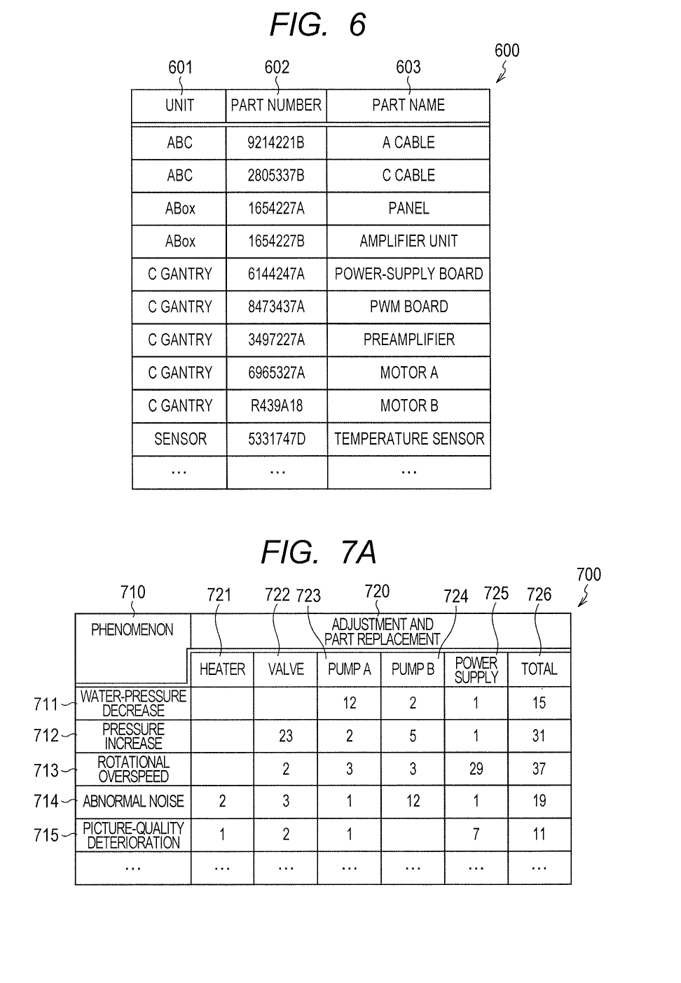

FIG. 5 shows alarm generation 502, field inspection existence/non-existence 503 and handling descriptions 504 for every alarm number 501. The handling descriptions 504 include reset 5041, adjustment 5042, part replacement 5043 and takeout inspection 5044. FIG. 6 is a part table 600 which typically has a unit column 601, a part-number column 602 and a part-name column 603.

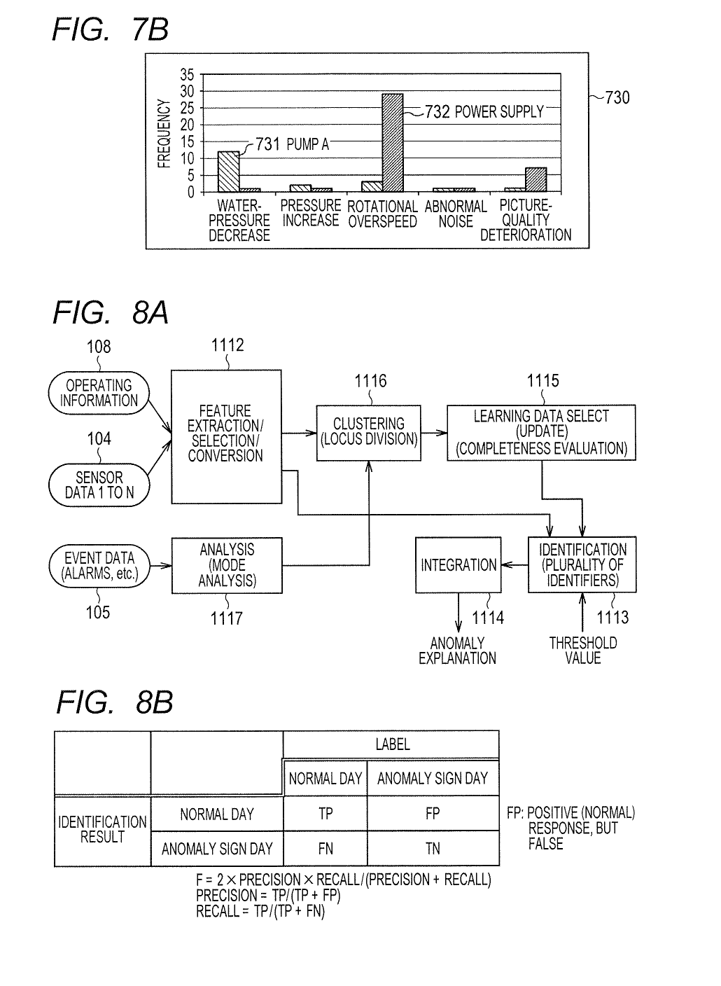

FIG. 7A is an inter-object association table 700 having a phenomenon column 710 and an adjustment/part replacement column 720. The inter-object association table 700 shows frequencies on the basis of linking. The frequencies for these keywords 721 to 725 are extracted and summed up to give a sum 726. The frequency data is used for creating a diagnosis model. It is to be noted that the phenomenon column 710 shows phenomena such as a water-pressure decrease 711, a pressure increase 712, an excessive rotation 713, an abnormal noise 714 and a picture quality deterioration 715. These phenomena can also be classified into groups each provided for a member of the equipment. In addition, usually, the picture quality deterioration 715 is further classified into details each provided for equipment in accordance with functional deteriorations or the like.

FIG. 7B shows a frequency pattern 730 provided for parts to serve as a pattern corresponding to phenomena. The figure shows sums of generation frequencies of the phenomena, which occur when adjustment and/or replacement of a part are carried out, for an A pump 731 and a power supply 732. (In actuality, keyword frequencies described in a work report can also be used. As an alternative, it is also possible to make use of keywords extracted on the basis of a result of an analysis carried out on an image recorded by typically a camera used by a person doing a work). The pattern of frequencies is a feature quantity of the bag-of-words method. It is possible to separate the adjustment and the part replacement from each other and find a sum for each of the adjustment and the part replacement or find sums independently of each other. Thus, each item of the frequency pattern is provided in a form allowing item addition and item editing.

It is to be noted that FIG. 7A shows results of operations carried out to find sums of results for the adjustment and part replacement. However, it is also possible to adopt a co-occurrence concept and regard phenomena occurring at the same time as a pair or a group composed of 2 or more sets. Then, such a group can also be regarded as one phenomenon. This pertains to the phenomenon classification 412 shown in FIG. 4A. It is to be noted that the phrase stating ‘phenomena occurring at the same time’ means phenomena occurring within a time period determined in advance. There are a case in which the occurrence order is taken into consideration and a case in which the occurrence order is not taken into consideration. If the occurrence order is taken into consideration, the law of causality has been kept in mind.

In addition, in FIG. 7B, each item of the frequency pattern 730 includes the number of inquiries issued by a person in charge of maintenance to a maintenance center and inquiry contents (described in a keyword).

The frequency pattern 730 comprising a variety of keyword types as described above can also be said to be a context representing, among others, the equipment installation condition, the anomaly generation condition, the maintenance condition, the part replacement condition and past examples. A context, a placement condition and others are added to a keyword serving as a sole base for the conventional search operation. In a manner, such a search operation can be conceivably carried out. In other words, so far, it is written in the ‘if then’ form so that, in the search operation, the usage condition is not capable of achieving the target. As a result, there are many cases in which the diagnosis of the ‘then’ portion and its countermeasure are wasted in the end. However, such an ineffective keyword expression/usage condition can be expressed more flexibly by making use of a frequency pattern to provide a form in which the target can be conceivably achieved. Thus, in comparison with the diagnosis/countermeasure based on ‘if then’, it is possible to implement a diagnosis with a much higher degree of reliability.

FIG. 8A is a diagram referred in the following explanation of an example-based method for detecting an anomaly. That is to say, this figure is referred to in the following explanation of example-based anomaly detection carried out by taking a multi-dimensional sensor signal as an object. In other words, this figure is a diagram referred in the following explanation of a typical multi-variable analysis. As described before, pieces of sensor data 1 to N denoted by reference numeral 104 are data acquired by the multi-dimensional time-series sensor-signal acquisition section 103 shown in FIG. 1. In this exemplary embodiment, the sensor data 104 and the operating data 108 of operating times and the like are supplied to the anomaly detection/diagnostic system 100 which then carries out feature extraction/selection/conversion 1112, clustering 1116 and learning data selection (updating) 1115 on the input data. For the multi-dimensional time-series sensor data 104, an identification section 1113 carries out a multi-variable analysis in order to output observation sensor data having values deflected from normal data or their synthesized value to an integration section 1114. If the integration section 1114 detects an anomaly or an anomaly sign, a diagnosis described above is started by carrying out typically a frequency-pattern collation operation based on the degree of contribution to the failure phenomenon and past examples. (As a matter of fact, it is not only the degree of contribution, but also a time cumulative sum serving as a frequency pattern).

In the clustering 1116, the sensor data is divided by mode into some categories in accordance with an operation state and the like. In addition to the sensor data, event data 105 is used. (The event data 105 includes data for on/off control of the equipment, a variety of alarms and periodical inspection/adjustment of the equipment). Then, on the basis of results of the analysis, learning data is selected and an anomaly diagnosis is carried out. The event data 105 is an input to the clustering 1116. On the basis of the event data 105, data is divided by mode into some categories. The analysis and the interpretation of the event data 105 are carried out by an interpretation/analysis section 1117.

In addition, an identification section 1113 carries out identification by making use of a plurality of identifiers whereas an integration section 1114 integrates results of the identification. Thus, it is possible to implement more robust anomaly detection. A threshold value serving as an input to the identification section 1113 is a threshold value used in determining whether or not an anomaly sign exists. A message explaining an anomaly is output by the integration section 1114.

FIG. 8B is a diagram showing a true-false table, an F value serving as a performance index and other information. The true-false table is referred to as a confusion matrix used for representing the performance of detection of anomaly sign. By making use of quantities TP, TN, FP and FN which are defined in the table, the following quantities are defined:

F=2×Precision×Recall/(Precision+Recall)

Precision(Degree of precision)=TP/(TP+FP)

Recall(Degree of recurrence)=TP/(TP+FN)

Success rate=FN/(FP+TN)

By the same token, misinformation taking a normal period as an abnormal one is defined by expression FN/(TP+FN). These performance indexes are used in improving the performance of detection of an anomaly sign.

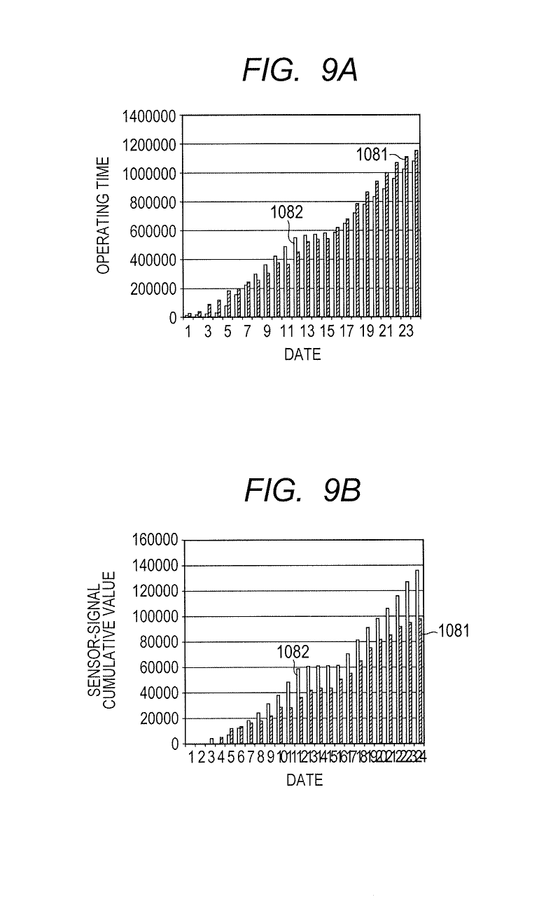

Typical operating data is shown in FIG. 9A. The typical operating data shown in FIG. 9A forms graphs for 2 pieces of equipment 1081 and 1082 having the same type but installed at different sites. Each of the graphs represents cumulative operating times computed for the equipment for day units. The horizontal axis represents days (expressed as relative values) whereas the vertical axis represents the cumulative values (also expressed as relative values) of the operating time. As is obvious from this figure, the 2 pieces of equipment 1081 and 1082 have almost equal operating times. That is to say, the 2 pieces of equipment 1081 and 1082 are known to operate in the same way. In the case of a large-size shovel used as mining equipment for example, there are a variety of operating times such as the running time of the shovel and the circling time thereof. Thus, the cumulative value can typically be an engine operating total time, an engine rotation number total time, engine cooling temperature total time or the like. What is described above also holds true for a small/medium-size shovel used on a street and a vibration roller used thereon. However, there are a variety of applications. Their operating times basically have relationships with deteriorations of the shovel. Thus, for a shovel that deterioration is early for the operating time, it is conceivably necessary to pay attention to maintenance.

It is needless to say that the deterioration of the equipment depends on past histories such as a past-replacement implementation history and an overhaul implementation history.

Information such as a latitude, a longitude and an altitude is input information which can be used as a reference in detection of an anomaly.

FIG. 9B is a diagram showing cumulative values of a coolant of an engine employed in a shovel. To be more specific, this figure shows typical cumulative values of sensor signals output by the 2 pieces of equipment 1081 and 1082 having the same type but installed at different sites. In this example, the cumulative values of the sensor signals output by the 2 pieces of equipment 1081 and 1082 show different trends. If the operating times like the ones shown in FIG. 9A for the 2 pieces of equipment 1081 and 1082 are not known, it is not possible to determine whether or not the difference in trend is good. In this example, the cumulative values of the sensor signals show different trends. If the cumulative values of the sensor signals show the same trend in spite of the fact that the operating times are different from each other, however, it is necessary to determine whether or not the same trend is good in conjunction with the operations.

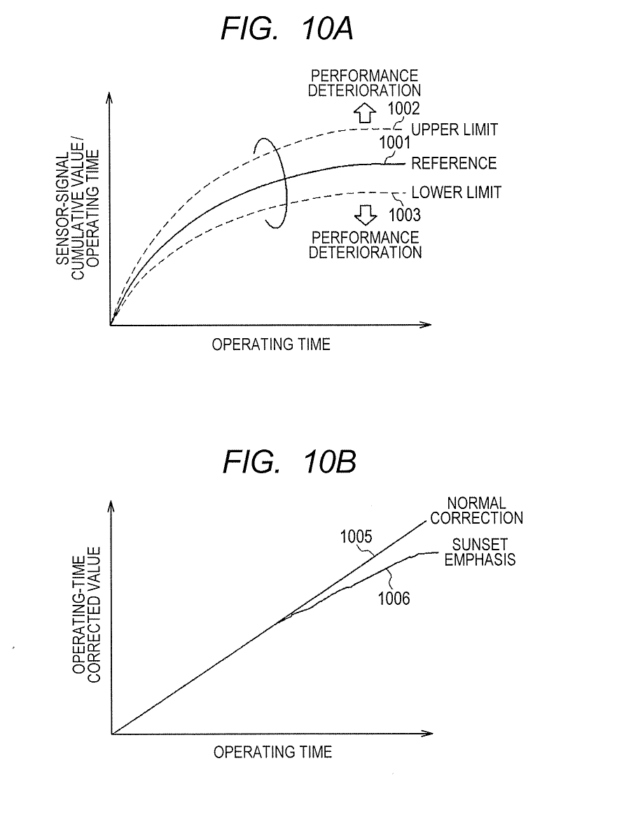

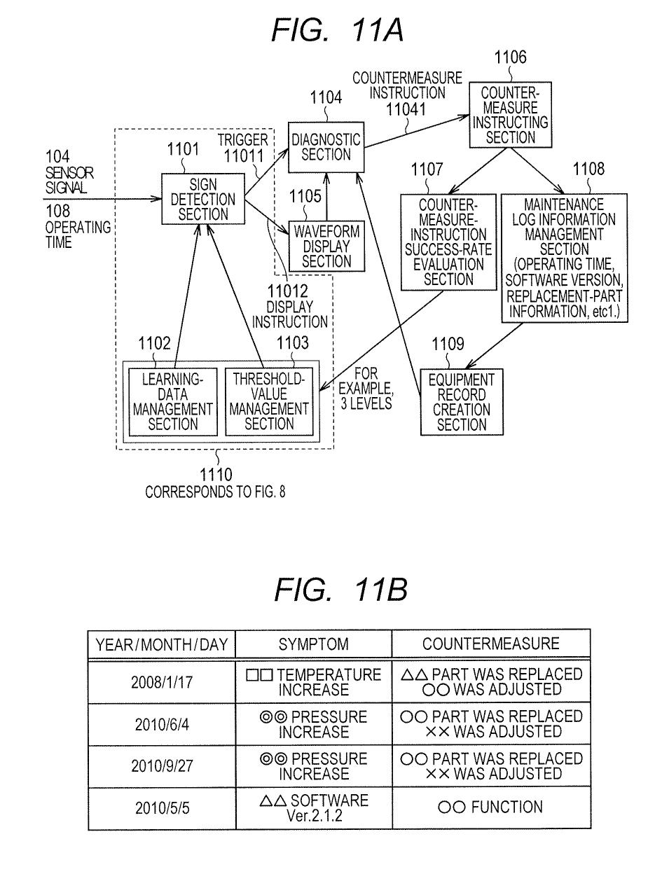

FIGS. 10A and 10B show the concept of calibration of cumulative values of sensor signals. By carrying out calibration at an operating time, the state of equipment of interest can be determined with a higher degree of precision from a relation indicating a state of being smaller or greater than a reference. The calibrated values are treated as observation or learning data. FIG. 10A shows typical results of normalization carried out on cumulative values of sensor signals by the operating time. An upper-limit curve 1002 and a lower-limit curve 1003 are set for a reference curve 1001. A value above the upper-limit curve 1002 and a value beneath the lower-limit curve 1003 indicate that the characteristic has deteriorated.

On the other hand, FIG. 10B shows how to calibrate the operating time itself. As shown in the figure, for a normal correction curve (a straight line) 1005, if care is required for an equipment state as is the case with the latter half of a life cycle or the like, correction is carried out in accordance with a non-linear curve 1006 and deflected data is emphasized (in a sunset emphasis). If it is desired to emphasize an initial fault, the operating initial period can also be made non-linear. In accordance with a bathtub curve representing the characteristic of the so-called failure, the sensitivity can be changed. This curve data is stored in a table or the like to be referred to later for each piece of equipment.

It is needless to say that both the operating time and the sensor signal can be summarized into a multi-dimensional vector and treated as observation data and/or learning data. In this case, for the learning data, it is necessary to prepare equipment data covering the range of the operating time. In other words, it is possible to handle data of a plurality of pieces of equipment having different operation and/or operating patterns and having different past operating times. It is thus possible to consider also the nature environment and the human environment, which surround the equipment, more objectively by making use of more data including levels of anomalies for each piece of equipment and possible to implement overall anomaly detection. Unambiguously, the following is not description about the operating time but, in the case of a shovel or a dump, typically, the cumulative value of the tonnage such as the amount of soil serving as the object is also considered to come near the operating time so that the cumulative value of the tonnage can be used as a component of the multi-dimensional vector described before. In addition, the number of periodical inspections, the number of replacement parts or the like can also be used as a component of the multi-dimensional vector described before.

The operating time has been described but, as a result of considering a variety of times, it is possible to carry out anomaly detection taking also into account the life cycle of the equipment.

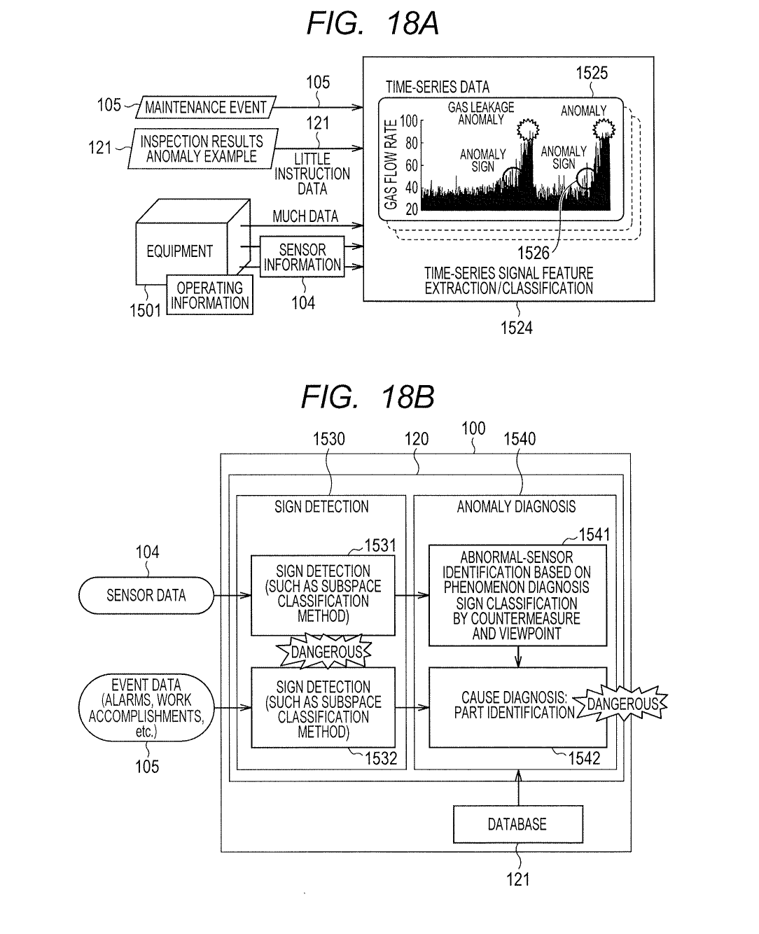

FIG. 11A shows an entire image of a maintenance work ranging from anomaly sign detection to countermeasure determination which is carried out by the anomaly detection/diagnostic system 100. A plurality of sensor signals 104 attached to the equipment and operating information 108 such as operating times are supplied to a sign detection section 1101 (which corresponds to a sign detection section 1530 explained later by referring to FIG. 18B). The sign detection section 1101 determines whether or not an anomaly sign exists. The sign detection section 1101 makes use of learning data managed by a learning-data management section 1102 and a threshold value managed by a threshold-value management section 1103 to monitor the existence of a deflection from a normal state as described before by referring to FIG. 8A. A portion 1110 comprising the sign detection section 1101, the learning-data management section 1102 and the threshold-value management section 1103 is a portion for carrying out the processing described before by referring to FIG. 8A.

If the sign detection section 1101 recognizes an anomaly sign as a result of processing the sensor signals 104 and the operating information 108, the sign detection section 1101 outputs a trigger 11011 to a diagnostic section 1104. At the same time, the sign detection section 1101 provides a waveform display section 1105 with a waveform display request signal 11012 indicating which data and waveform of the sensor signals and the operating information are to be observed. Thus, the waveform display section 1105 displays the requested data and waveform of the sensor signals and the operating information.

The diagnostic section 1104 receiving the trigger 11011 of the maintenance work carries out a diagnosis by adoption of the method explained before by referring to FIG. 4A. It is needless to say that information is also supplied to a person in charge of maintenance for a confirmation purpose. Information obtained as a result of the diagnosis carried out by the diagnostic section 1104 includes a countermeasure candidate 11041 which is displayed on a display screen to serve as a requested candidate for a countermeasure. Then, a countermeasure instructing section 1106 carries out the requested countermeasure. Since it is possible to determine whether or not the countermeasure proposal is proper, a countermeasure-instruction success-rate evaluation section 1107 for the request for a countermeasure is allowed to evaluate the success rate of the request for the countermeasure.

An anomaly sign is detected as described earlier by referring to FIG. 8B. In the following description, the detection of an anomaly sign is widened to include a

countermeasure. In the case of a countermeasure, if about 3 success levels are used as the success rate, the number of success levels is deemed to be proper. That is to say, at the first success level, the countermeasure is deemed to be successful because the operation of the equipment has been improved by the countermeasure. At the second success level, the countermeasure is deemed to be not successful because it is not necessary to restore the operation of the equipment to normalcy. At the third success level, a countermeasure is not required. The maintenance-history information is managed by a maintenance history information management section 1109. On the other hand, an equipment-record creation section 1109 generates typically records making it possible to detect typically a symptom existing in the equipment.

FIG. 11B shows typical records of pieces of equipment. The records include software-version information and part-replacement information for each piece of equipment. The records of pieces of equipment are also used in studies of countermeasures and countermeasure verification.

The success rate computed for the request for a countermeasure by the countermeasure-instruction success-rate evaluation section 1107 provided for the request for a countermeasure is used in operations carried out by the

learning-data management section 1102 to update and correct learning data of an anomaly sign, an operation carried out by the threshold-value management section 1103 to correct a threshold value and other operations. On the other hand, the sensitivity for an anomaly sign is corrected by the sign detection section 1101. In the case of an anomaly sign not requiring a countermeasure for example, the threshold value is raised to suppress the sensitivity. A threshold value used as an input to the identification section 1113 shown in FIG. 8A is controlled. When an anomaly sign is detected due to insufficient learning data, learning data is added. In a learning-data select (update) section 1115 shown in FIG. 8A, learning data is added.

In addition, the waveform display section 1105 stores a valid sensor signal for every failure and displays it preferentially.

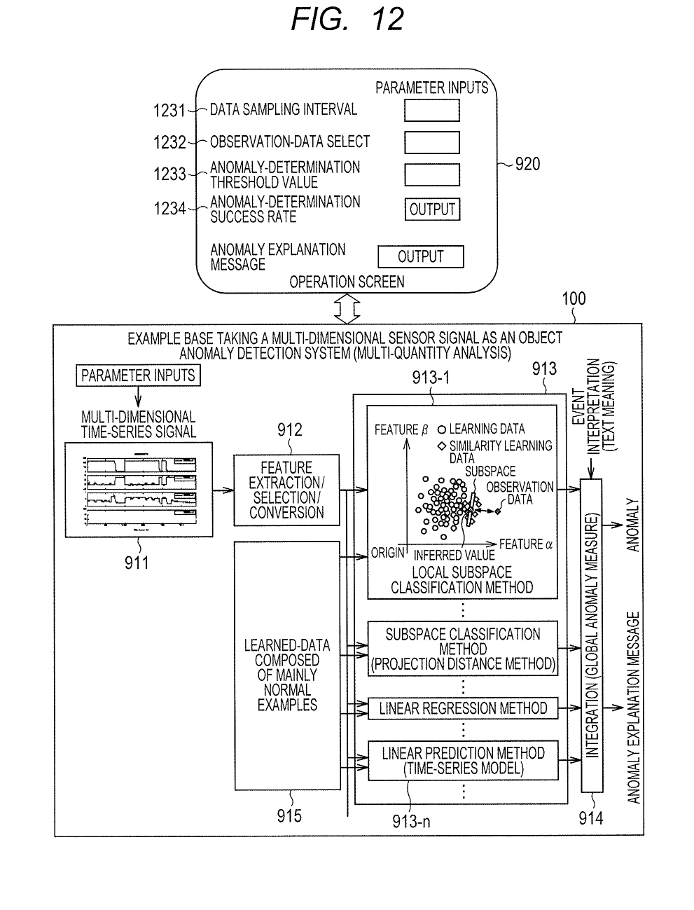

FIG. 12 shows the internal configuration of the anomaly detection/diagnostic system 100 for carrying out anomaly detection processing based on an example base. In this anomaly detection, reference numeral 912 denotes a feature extraction/selection/transformation section that receives a multi-dimensional time-series signal 911 based on a variety of sensor signals 104 acquired by the multi-dimensional time-series signal acquisition section 103 and processes the multi-dimensional time-series signal 911. Reference numeral 913 denotes an identifier whereas reference numeral 914 denotes an integration processing section (global anomaly measure). On the other hand, reference numeral 915 denotes a learning-data storage section used for storing learning data composed of mainly normal examples.

The feature extraction/selection/transformation section 12 reduces the number of dimensions of the multi-dimensional time-series signal received from the multi-dimensional time-series signal acquisition section 911. The output of the feature extraction/selection/transformation section 912 is identified by a plurality of identifiers 913-1, 913-2, . . . and 913-n which are employed in the identifier 913. The integration processing section 914 (global anomaly measure) determines the global anomaly measure. The learning data stored in the learning-data storage section 915 as data composed of mainly normal examples is also identified by the identifiers 913-1, 913-2, . . . and 913-n and used in the determination of the global anomaly measure. In addition, the learning data itself is subjected to a selection process of taking or discarding the data. In this way, the learning data is stored in the learning-data storage section 915 and updated in order to improve the precision. As described above, the learning data is data stored in the learning-data storage section 915 as data composed of mainly normal examples.

Learning data is updated as follows. Similarities of data are evaluated. Data similar to other data is considered to be a duplicate of the other data. Thus, the data similar to the other data is eliminated. When normal data dissimilar to other data is observed, the normal data is added.

As described above, learning data can be added and removed automatically. Thus, it is possible to shorten the time required to determine an anomaly.

To put it concretely, the following procedures are executed.

Preparation Work (Offline)

(i): Acquire learning data (No. 1 to M)
(ii): Compute distances for all pieces of learning data
(iii): Set a distance order for the pieces of learning data

(Set a table showing numbers assigned to the pieces of learning data in a distance order starting with data having the shortest distance).

(iv): For data with long distances, verify adequacy

(If there is a data with a long distance which is important, it is feared that learning data may not be adequate)

(v): Store the above order as a table

Diagnosis Start

For 1st (j=1) point (observation query) of observation data
(i): Compute the distances of the learning data
(ii): Take N upper ones as search data
(iii): Select k ones in accordance with the local subspace classification method LSC
For 2nd (j=2) point and subsequent points of observation data
(iv): Compute the distance d(j) between the (j−1)th point of the observation data and the jth point of the data
(v): Select learning data ranging from the closest learning data selected at the (j−1)th point of the observation data to the learning data separated by a distance min {d(j), th} where notation th denotes a threshold value used as an upper limit
(vi): Further select N closest pieces of learning data from every learning data selected as described above
(vii): Take learning data covering (N+α) ones as data to be searched

(If (N+α) is small, the processing speed can be increased)

(viii): Select k ones in accordance with the LSC (Store the closest pieces of learning data to be used at the next (j+1)th point)
(ix): Repeat procedure steps from (iv) to (vii) described above
(x): Keep the utilized learning data and delete learning data utilized at low frequencies

(In the case of a diagnosis object for which the learning-data updating itself is repeated, procedure step (x) is not required).

Its way of thinking is explained as follows. While the amount of learning data is being minimized, variations of the learning data are followed and the range is widened by variations of observation data from a previously searched range.

FIG. 12 also shows the screen 920 of an operation PC. The screen 920 is displayed on the input section 123 for receiving parameters entered by the user. The parameters entered by the user to the input section 123 include a data sampling interval 1231, an observation data select 1232 and an anomaly determination threshold value 1233. The data sampling interval 1231 is an interval at which data is to be acquired. The data sampling interval 1231 is typically expressed in terms of seconds.

The observation data select 1232 is an instruction indicating which sensor signals are to be used. The anomaly determination threshold value 1233 is a threshold value for binary conversion of a value representing the degree of anomaly. The observation data select 1232 represents, among others, a computed variance/deviance from a model, a deviation value, a separation and an anomaly measure.

A success rate 1234 of the anomaly detection is a numerical value (output) indicating whether or not an anomaly sign detected in the past is accurate. As described before by referring to FIG. 8B, in addition to the success rate, the degree of a false alarm and the like can be displayed. The performance indexes such as the success rate and the degree of falseness are used in operations to update and correct the learning data of an anomaly sign, an operation to correct a threshold value and other operations. In this way, the sensitivity for an anomaly sign is corrected.

The identifier 913 shown in FIG. 12 includes some prepared identifiers 913-1 . . . and 913-n. The integration processing section 914 is capable of determining a majority of the identifiers 913-1 . . . and 913-n. That is to say, it is possible to apply ensemble learning making use of the identifiers 913-1 . . . and 913-n (integration). For example, the first identifier 913-1 is the projection distance method whereas the second identifier is the local subspace classification method. On the other hand, the third identifier is the linear regression method whereas the fourth identifier is a Gaussian-process method which is a non-linear regression method. Any arbitrary identifier can be adopted as long as the identifier is based on example data. Gaussian processes are explained in NPTL 3.

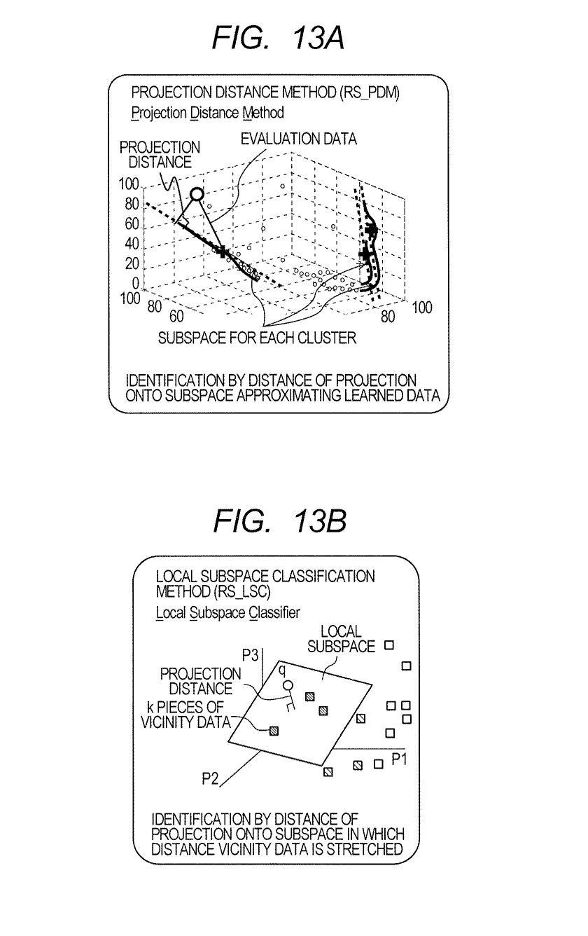

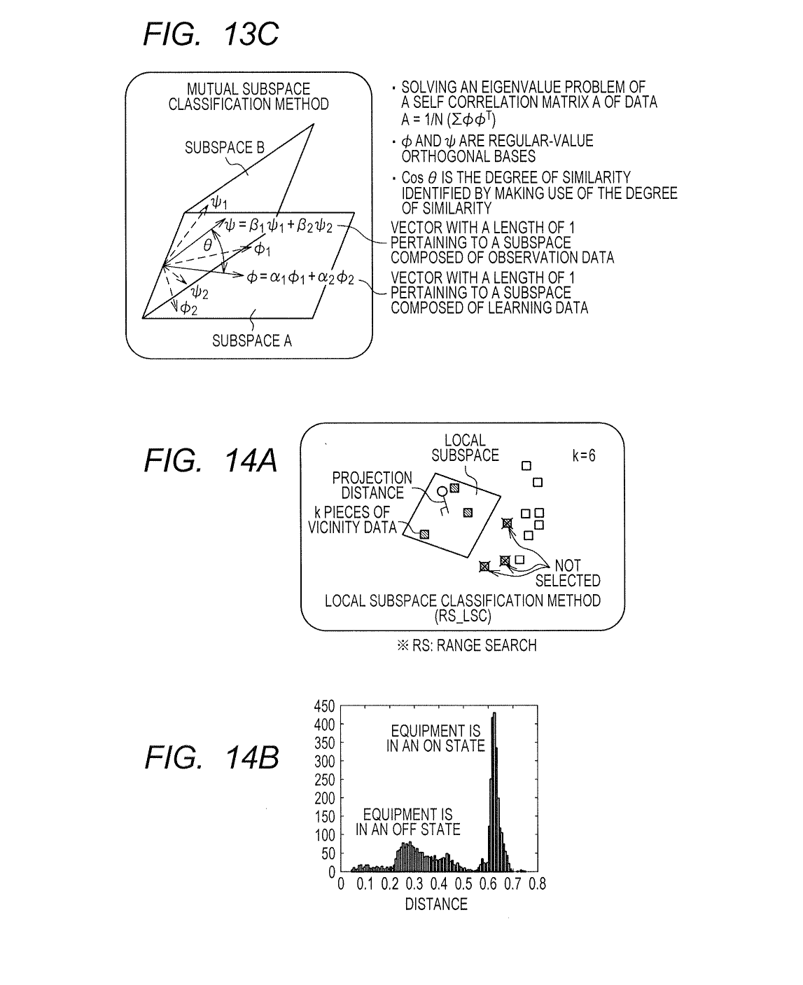

FIGS. 13A to 13C are diagrams referred to in description of typical identification methods adopted in the identifier 913. To be more specific, FIG. 13A is a diagram referred to in description of the projection distance method. The projection distance method is an identification method making use of the distance of projection onto a subspace approximating learning data.

In accordance with the projection distance method, first of all, an average mᵢ of the learning data {xⱼ} for each cluster and a variation matrix Σᵢ are found by making use of the following equation:

$${m}_{i} = \frac{1}{{n}_{i}} {\sum }_{j ∈ {ω}_{j}} {x}_{j} , {\sum }_{i} = \frac{1}{{n}_{i}} {\sum }_{j ∈ {ω}_{i}} ( {x}_{j} - {m}_{i} ) {( {x}_{j} - {m}_{i} )}^{T} \qquad ( 1 )$$

In the above equation, symbol nᵢ denotes the number of learning patterns belonging to a cluster ωᵢ.

Then, an eigenvalue problem of the variation matrix Σᵢ is solved and, on the basis of a cumulative contribution ratio, a matrix Uᵢ arranging eigenvectors corresponding to the r eigenvalues starting with the largest one is taken as an orthonormal basis of an affine subspace of the cluster ωᵢ. The minimum value of the projection distance to the affine subspace is defined as an anomaly measure of an unknown pattern x. In spite of 1-class classification making use of only normal learning data, the learning data itself includes different conditions such as the ON/OFF operating conditions. Thus, for the learning data, a subspace is generated with k-vicinity data close to observation data taken as one cluster. At that time, learning data whose distance from the observation data falls in a range determined in advance is selected (an RS method or a Range Search method). In addition, L (times t−t1 to t+t2, t1 and t2 are determined by the consideration of sampling) pieces of learning data are also used to generate a subspace (time extension RS method). The L pieces of learning data are data which should correspond to variations of the transient time and leads ahead of or lags behind the selected data in the direction of the time axis. On top of that, the projection distance is selected so that its value is smallest among those in a range from a smallest count to a selection count.

For 1 point of observation data, minimum learning data is selected. With only 1 point of observation data, however, whether or not the sensitivity is highest is not clear. Thus, as will be described later (FIG. 13C is a diagram to be referred to in explanation of a mutual subspace classification method), also for the observation data, a subspace is generated. In the learning data, a subspace is generated from L×k sets (or smaller) of data selected by adoption of the time extension range search method. For the observation data, however, the length of the window segment is a kind of freedom and the selection is key to it. If the length of the window segment is increased, the variations of the data are caught. Since the data in the window is independent from time, however, the degree of fear that a variation cannot be detected increases, furthermore, handling of the learning data will no longer be corresponding to it.

On the basis of the dimension count n of the subspace in which learning data is stretched, a minimum window segment of the observation data is determined. The dimension count n is computed from the cumulative contribution ratio. Under a condition that the number of pieces of observation data is equal to the maximum (n+1), on the basis of the dimension count, the window segment length M of the observation data is determined in an exploratory manner and the subspace is generated. Then, cos θ or its square is found where θ denotes an angle formed by subspaces. A planning method is characterized in that, in accordance with this method, for time-series data, first of all, a minimum learning subspace is generated, then, from the similarity standpoint and the time-window standpoint, observation data is selected properly and, finally, similar subspaces are generated successively.

It is to be noted that, in the projection distance method, the center of gravity of classes is taken as an origin. An eigenvector obtained by applying the KL expansion to a covariance matrix of classes is used as a base. A variety of subspace classification methods have been proposed. If the method has a distance scale, however, the degree of deviation can be computed. It is to be noted that, also in the case of the density, by making use of its quantity, the degree of deviation can be determined. In the projection distance method, the length of the orthogonal projection is found. Thus, the projection distance method makes use of a similarity scale.

As described above, in a subspace, a distance and a similarity degree are computed whereas the degree of deviation is evaluated, to thereby determine whether or not an anomaly sign exists compared with a threshold value. In the subspace classification method such as the projection distance method, due to an identifier based on a distance, as a learning method for a case in which anomaly data can be used, it is possible to make use of metric learning for learning a distance function and vector quantization for updating a dictionary pattern.

FIG. 13B shows another example of the projection distance method of the identifier 913. This example is a method referred to as a local subspace classification method. The local subspace classification method is an identification method based on a projection distance to a subspace in which short-distance data is stretched. In accordance with the local subspace classification method, first of all, k multi-dimensional time-series signals close to an unknown pattern q (a most recent observed pattern) are found. Then, a linear manifold for which a closest pattern of classes serves as an origin is generated. Finally, the unknown pattern is classified into a class which makes the projection distance to the linear manifold shortest. The local subspace classification method is also one of subspace classification methods. The signal count k representing the number of multi-dimensional time-series signals is a parameter. In detection of an anomaly, the distance from the unknown pattern q (a most recent observed pattern) to the normal class is found and used as a deviation (or a residual error) to be compared with a threshold value.

In this method, for example, a point correctly projected from the unknown pattern q (a most recent observed pattern) onto a subspace created by making use of the k multi-dimensional time-series signals can also be computed as an inferred value.

In addition, the k multi-dimensional time-series signals can also be rearranged into an order starting with the signal closest to the unknown pattern q (a most recent observed pattern) and multiplied by weights inversely proportional to the distances in order to compute inferred values of the signals. By adoption of the projection distance method or the like, the inferred values of the signals can also be computed as well.

The parameter k is normally set at 1 type. If the processing is carried out by setting the parameter k at a type which can be changed to one of several other types, however, object data is selected in accordance with the degree of similarity. In this case, since comprehensive determination is made from their results, the method becomes more effective.

In addition, as shown in FIG. 14A, as the value of the parameter k in the local subspace classification method, learning data is selected. The selected learning data must have a value proper for every observation data and the distance between the selected learning data and the observation data is within a range determined in advance. On top of that, the number of pieces of learning data can be increased sequentially from a minimum value to a select value and learning data having a shortest projection distance can be selected.

What is described above can be applied to the projection distance method. To put it concretely, the procedure is described as follows.

1. Compute distances from the observation data to the learning data and rearrange the distances in an increasing order.
2. If the distance d<a threshold value th and the distance d is not greater than the parameter k, select the learning data.
3. Compute the projection distance for the range j=1 to k and output the minimum value.

The threshold value th used in the procedure described above is determined experimentally from the frequency distribution of the distance. FIG. 14B shows a distribution seen from observation data as the frequency distribution of the distance for the learning data. In this example, the frequency distribution of the distance for the learning data is a curve having a form of 2 mountains corresponding to respectively the on and off states of the equipment. The 2 mountains and 1 valley represent a transient period from the on state to the off state of the equipment or the reversed transient period from the off state to the on state of the equipment.

This notion is a concept referred to as a range search (RS) concept. This notion is thought to be applied to selection of learning data. The range search concept of learning-data selection can be applied also to the methods disclosed in PTL 1 and PTL 2. It is to be noted that, in the local subspace classification method, even if abnormal values are mixed in the data a little bit, the influence of the abnormal values is reduced substantially by forming the local-subspace.

It is to be noted that, as shown in none of the figures, in identification referred to as an LAC (Local Average Classifier) method, the center of gravity for k pieces of close data is defined as a local subspace. Then, the distance from the unknown parameter q (a most recent observed pattern) to the center of gravity is found and used as a deviation (or a residual error).

FIG. 13C is a diagram referred to in description of a technique called a mutual subspace classification method. A subspace is used for modeling not only learning data, but also observation data. In this case, the observation data is N pieces of time-series data traced back to the past. In the mutual subspace classification method, an eigenvalue problem of a self correlation matrix A of data is solved. The self correlation matrix A is expressed by an equation (Eq. 2) given as follows:

A=1/N(Σφφ^{τ}) (2)

In FIG. 13C, notations φ and ψ denote normal orthogonal base of a subspace. In addition, cos θ represents the degree of similarity. The degree of similarity is used to evaluate observation data, whereby an anomaly sign can be detected compared with a threshold value. The mutual subspace and its extension are described in documents such as “Actions of Nuclear Non-linear Mutual Subspace classification method” authored by Seiji Horita, Tomokazu Kawahara, Osamu Yamaguchi and Ei Sakano, a communication technical report, PRMU 2010, Vol. 110, No. 187, pp. 1 to 6, September 2010.

The example shown in FIG. 12 as a typical identification method of the identifier 913 is presented as a program. It is to be noted that, if thought simply as a one-class identification problem, an identifier such as a one-class support vector machine can also be applied. In this case, kernel conversion such as a radial basis function, which is a conversion for mapping onto a high-order space, can be used.

In the one-class support vector machine, the side close to the origin is a deflected value, that is, an anomaly. The support vector machine is capable of keeping up with even a high dimension of the feature quantity. But, there is a demerit that, as the learning-data count increases, the amount of computation also rises as well.

In order to deal with the demerit, it is possible to apply typically a technique announced in the MIRU 2007 (which is a Meeting on Image Recognition and Understanding 2007). The document describing the technique is IS-2-10, “One-class Identifiers Based on Pattern Adjacency” authored by Takekazu Kato, Mami Noguchi, Toshikazu Wada (Wakayama University), Kaoru Sakai and Shunji Maeda (Hitachi). This announced technique offers a merit that, even if the learning-data count increases, the amount of computation does not rise.

By expressing a multi-dimensional time-series signal by a low-dimensional model as described above, a complicated state can be decomposed and expressed by a simple model. Thus, there is provided a merit that the phenomenon is easy to understand. In addition, in order to set a model, it is not necessary to prepare data completely as is the case with the methods disclosed in PTL 1 and PTL 2.

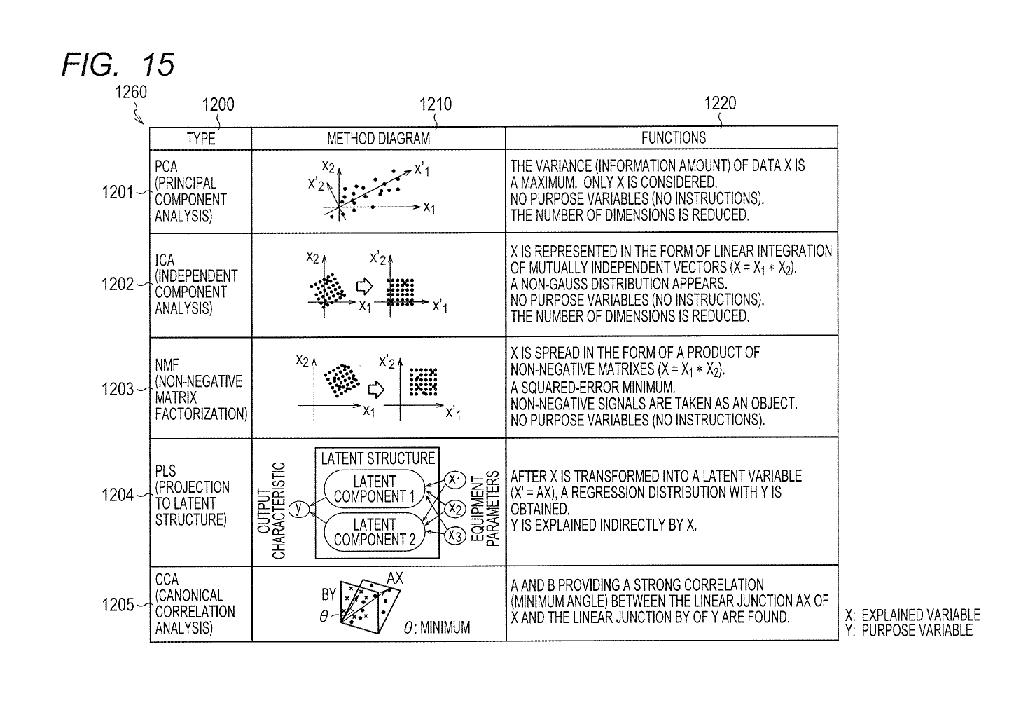

FIG. 15 shows an example of feature conversion 1200 for reducing the number of dimensions of sensor data 1 to N denoted by reference numeral 104. The sensor data 1 to N is a multi-dimensional time-series signal shown in FIG. 11A as a signal acquired by the multi-dimensional time-series signal acquisition section 103. As types 1260, in addition to a principal component analysis 1201, it is also possible to apply some techniques such as an independent component analysis 1202, a non-negative matrix factorization 1203, a latent structure projection 1204 and a canonical correlation analysis 1205. FIG. 15 shows both method diagrams 1210 and functions 1220.

The principal component analysis 1201 is referred to as a PCA for linearly transforming a multi-dimensional time-series signal having a dimension count M into an r-dimensional time-series signal having a dimension count r. The principal component analysis 1201 is also used for generating an axis with a maximum number of variations. KL transformation can also be carried out. The dimension count r is determined on the basis of a value serving as a cumulative contribution ratio obtained by dividing an eigenvalue by the sum of all eigenvalues. The divided eigenvalue is a value obtained by arranging eigenvalues found by a principal component analysis in a descending order and summing up them by starting with a large one.

The independent component analysis 1202 is referred to as an ICA and has an effect of a technique for actualizing a non-gaussian distribution. The non-negative matrix factor decomposition is referred to as NMF (Non-negative Matrix Factorization). Sensor signals given in the form of a matrix are decomposed into non-negative elements.

An item provided on the column of the function 1220 which is written as “no instruction” is an effective transformation method in case having an item with few anomaly examples as is the case with this exemplary embodiment. In this case, an example of the linear transformation is shown. Non-linear transformation can also be applied.

The feature transformation described above includes normalization for normalizing by making use of standard deviations and is implemented at the same time by arranging learning data and observation data. By doing so, it is possible to handle learning data and observation data on the same column.

FIG. 16 is an explanatory diagram referred to in description of a sign detection technique developed for anomaly generation as a technique making use of a residual-error pattern. FIG. 16 shows a technique of similarity-degree computation of a residual-error pattern. FIG. 16 expresses deviations as loci in a space. The expressed deviations are deviations of a sensor signal A, a sensor signal B and a sensor signal C which are generated at points of time from a normal center of gravity. This normal center of gravity corresponds to the normal center of gravity of pieces of learning data found by adoption of the local subspace classification method. To put it accurately, the axes represent principal components.

In FIG. 16, a residual-error series of observation data is shown as a dashed line having an arrow and passing through times (t−1), t and (t+1). The degree of similarity for each of the observation data and anomaly examples can be inferred by computing the inner product (A·B) of their deviations A and B. In addition, the inner product (A·B) can be divided by the magnitude (norm) and the degree of similarity can be inferred by the angle θ. For a residual-error pattern of the observation data, the degree of similarity is found and, by making use of its locus, an anomaly sign as an anomaly to be generated is inferred.

To put it concretely, FIG. 16 shows a deviation 1301 of an anomaly example A and a deviation 1302 of an anomaly example B. If a deviation series pattern of observation data including the times (t−1), t and (t+1) on the dashed line having an arrow is looked at, at the time t, it is close to the anomaly example B. From its locus, however, it is possible to predict generation of the anomaly example A instead of the anomaly example B. If there is no past anomaly example corresponding to an anomaly sign detected in the past, the anomaly sign can be determined to be a sign predicting a new anomaly. In addition, a space shown in FIG. 16 is divided by a zone having the shape of a circular cone having a vertex coinciding with the origin and, then, an anomaly can be identified by making use of the zone.

In order to predict an anomaly example, locus data of a deviation (residual error) time series up to the generation of the anomaly example is stored in a database in advance. Then, the degree of similarity between the deviation (residual error) time-series pattern of the observation data and the deviation (residual error) time-series pattern stored in the locus database as a pattern for locus data can be computed in order to detect a sign predicting generation of an anomaly.

If such a locus is displayed to the user through a GUI (Graphical User Interface), the state of generation of an anomaly can be visually expressed and reflected with ease in a countermeasure or the like.

If only comprehensive residual errors are traced and development with the lapse of time is ignored, an anomaly phenomenon is difficult to understand. If the development of a residual vector with the lapse of time is followed, however, the phenomenon can be picked up and understood. Theoretically, by carrying out processing to sum up vectors of each of several events forming a compound event, it is possible to detect a signal predicting generation of an anomaly for the compound event and the fact that a residual vector accurately expresses an anomaly can be understood. If the loci of past anomaly examples such as the past anomaly examples A and B have been stored in a database as known information, an observed locus of an anomaly can be collated with the stored loci in order to identify (diagnose) the type of the anomaly.

In addition, if FIG. 16 is viewed as generation of a residual vector in a fixed time window, it can be expressed as a frequency. If it can be handled as a frequency, it is possible to acquire frequency distribution information having a form like the one shown in FIG. 7B. It can thus be handled as the frequency of appearance of a keyword for the phenomenon. That is to say, it can be used in a diagnosis. In order to handle the residual vector shown in FIG. 16 as a frequency, each axis of FIG. 16 is segmented into a fixed width and determination as to whether or not it is included in cubic zones is made to create a frequency distribution. In FIG. 16, a 3-dimensional frequency distribution is obtained or, normally, a multi-dimensional frequency distribution is obtained. By arrangement along a vertical column or the like, however, transformation into a 1-dimensional frequency distribution (or conversion into a vector) is possible so that it can be handled as an ordinary frequency distribution or a frequency pattern.

FIG. 17 shows the hardware configuration of the anomaly detection/diagnostic system 100. As shown in the figure, this system is configured to include a processor 120, a database (DB) 121, a display section 122 and an input section (I/F) 123. The processor 120 for carrying out detection of an anomaly inputs sensor data 104 from typically an engine serving as an object and carries out typically recovery of defective values. The processor 120 then stores the sensor data 104 in the database (DB) 121. The processor 120 carries out detection of an anomaly by making use of the acquired observed sensor data 104 and DB data stored in the database (DB) 121 which is used for storing learning data. The display section 122 displays various kinds of information and outputs a signal indicating the existence or the non-existence of an anomaly. The display section 122 is also capable of displaying a trend. In addition, the display section 122 is also capable of displaying a result of an interpretation of an event. On top of that, the processor 120 makes an access to the database (DB) 121 used for storing maintenance-history information and the like in order to search the database (DB) 121 for a keyword. The processor 120 then retrieves the keyword found in the search in order to generate a diagnosis model used for diagnosing an anomaly. Then, the processor 120 displays a result of the anomaly diagnosis on the display section 122. In particular, for a fault tree (a diagnosis procedure) describing an inspection work carried out in the field, the processor 120 classifies sensor data as seen from the countermeasure and part replacement points of view and, at the stage of detecting an anomaly sign, indicates typically a branch point which should be checked initially in an operation carried out on the equipment.

Results of a diagnosis include a diagnosis model shown in FIGS. 4A to 4E. That is to say, the figures show, among others, a result of a diagnosis of a phenomenon, a result of classification of the phenomenon and the diagnosis model. In addition, the display also includes various kinds of information shown in FIGS. 5, 6 and 7A as well as 7B. In particular, the frequency histogram shown in FIG. 7B is an important display factor serving as information that makes the frequency pattern shown in FIG. 7A visible. A portion of a context is selected and displayed. In this case, the selected and displayed context is a context representing, among others, an equipment installation condition, an anomaly generation condition, a maintenance condition, a condition leading to replacement of a part and past examples. They can be edited at a standpoint of item margins or the like.

In addition, the display section 122 displays not only results of a diagnosis, but also the success rate for the results. Thus, it is possible to make the results of a diagnosis visually observable and to carry out the PDCA cycle.

The success rate is expressed by a typical equation given as follows:

Success rate=Valid countermeasure/Presented countermeasure proposal

Separately from the hardware described above, a program to be installed in the hardware can be presented to the customer through a program recording medium or an online service.

A skilled engineer or the like is capable of making use of the database (DB) 121. In particular, anomaly examples and countermeasure examples can be stored in the database (DB) 121 as past experiences. To be more specific, the database (DB) 121 can be used for storing (1) learning data (normal data), (2) anomaly data, (3) countermeasure descriptions and (4) a fault tree (Expressing a diagnosis procedure as a tree structure like the if-then format). The database (DB) 121 is structured so that a skilled engineer or the like is capable of manually modifying the data stored in the database (DB) 121. Thus, a sophisticated and useful database can be provided. In addition, a data operation is carried out by automatically transferring learning data (pieces of data and the position of the center of gravity) in accordance with generation of an alarm and/or replacement of a part. In addition, acquired data can be added automatically. If the data of an anomaly exists, a technique such as the generalization vector quantization can be applied to the transfer of the data.

In addition, the loci of the past anomaly examples A and B and the like explained earlier by referring to FIG. 16 are stored in the database (DB) 121 and the type of an anomaly is identified (or diagnosed) by collation with the loci. In this case, the loci are expressed as data in an N-dimensional space and stored. Data is processed by the processor 120 and displayed by the display section 122 in accordance with requests made by the input unit (I/F) 123.

FIGS. 18A and 18B show detection of an anomaly and a diagnosis after the detection of the anomaly. In FIG. 18A, a time-series signal (a sensor signal) 104 received from the multi-dimensional time-series signal acquisition section 103 receiving the signal from equipment 1501 is subjected to signal processing before being subjected to feature extraction/classification 1524 of the time-series signal 104 in the processor 120 in order to detect an anomaly. The number of pieces of equipment 1501 is not limited to one. A plurality of pieces of equipment 1501 can also be perceived as one object. At the same time, supplementary information such as an event 105 of maintenance of the pieces of equipment is taken in, in order to detect an anomaly with a high degree of sensitivity. (In this case, the event 105 is an alarm, a work accomplishment or the like. To put it concretely, the event 105 can be activation of equipment, stop of equipment, setting of an operating condition, various kinds of failure information, various kinds of warning information, periodic inspection information, an operating environment such as the temperature of the installation site, a cumulative operating time, part replacement information, adjustment information or cleaning information to mention a few).

In FIG. 18A, the waveform 1525 of time-series data shown in the feature extraction/classification 1524 of the time-series signal 104 represents an observed signal whereas an anomaly detected in this exemplary embodiment is shown by a circular mark 1526 as an anomaly sign. In the case of an anomaly sign, the anomaly measure is at least equal to a threshold value determined in advance (or the anomaly measure exceeds a threshold value a number of times exceeding a number set in advance). In such a case, an anomaly sign is determined. In this example, prior to stop of equipment, an anomaly sign can be detected and a countermeasure which should be taken can be implemented.

As shown in FIG. 18B, if a predictive detection section 1530 of the processor 120 employed in the anomaly detection/diagnostic system 100 is capable of detecting an anomaly sign as a predicted one at an early time, prior to stop of the operation due to a failure caused by the anomaly, some countermeasures can be taken. Then, the sensor data 104 is processed and the anomaly sign is detected (1531) by adoption of the subspace classification method or the like. Subsequently, event data 105 is input and event-array collation and the like are added in order to comprehensively determine whether or not the anomaly sign indeed exists (1532). On the basis of this anomaly sign, by adoption of the methods explained earlier by referring to FIGS. 4A to 4E, an anomaly analysis section 1540 carries out an anomaly analysis in order to identify candidates for failing parts and infer a future time at which the parts will fail, causing the operation to be stopped. Then, the required parts are prepared as replacement parts to be installed with a correct timing.

The anomaly analysis section 1540 is easy to understand if the reader thinks that the anomaly analysis section 1540 comprises a phenomenon analysis section 1541 and a cause analysis section 1542. The phenomenon analysis section 1541 is a section for carrying out a phenomenon analysis to identify a sensor including an anomaly sign and for classifying anomalies from the countermeasure point of view and the part replacement point of view. On the other hand, the cause analysis section 1542 is a section for identifying a part which most likely causes a failure. The sign detection section 1530 provides the anomaly analysis section 1540 with a signal indicating whether or not an anomaly exists and information on feature quantities. On the basis of the signal indicating whether or not an anomaly exists and the information on feature quantities, the phenomenon analysis section 1541 employed in the anomaly analysis section 1540 carries out a phenomenon analysis by making use of information stored in the database (DB) 121. The phenomenon analysis section 1541 also classifies phenomena. In addition, the phenomenon analysis section 1541 also classifies sensor data from, among others, the adjustment point of view and the countermeasure point of view. That is to say, on the basis of the methods explained earlier by referring to FIGS. 4A to 4E, the cause analysis section 1542 makes use of information stored in the database (DB) 121 in order to recommend places to be checked and identify places to be adjusted. In this way, a cause analysis is carried out to identify a part to be replaced.

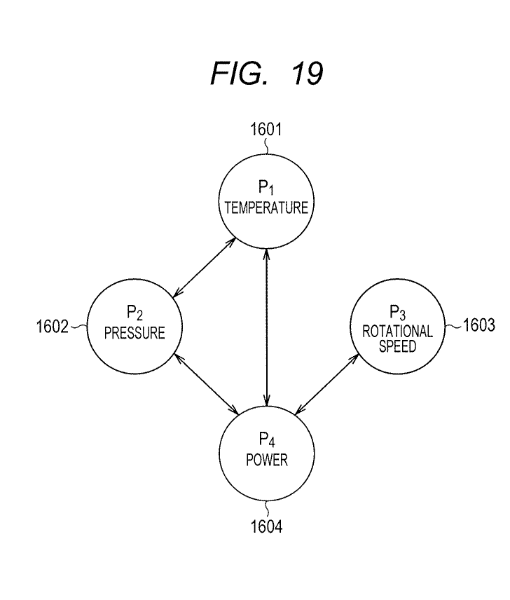

FIG. 19 shows an example of creating a network of sensor signals from information on the quantity of an obtained effect on anomalies of the sensor signals. With regard to sensor signals such as the basic temperature 1601, a pressure 1602, the rotational speed 1603 of a motor or the like and an electric power 1604, on the basis of the rates of the quantity of an effect on the anomaly, weights can be applied to the sensor signals. These relations are also utilized as a keyword in the analysis model explained earlier by referring to FIGS. 4A to 4E.

If such a relevant network is available, the designer is capable of clearly showing, among others, the signal connection, the signal co-occurrence and the signal correlation which are not shown in the figure and also useful for an analysis of an anomaly. Such a network is generated at scales such as correlation, similarity, distance, cause-effect relationship and phase-lead/phase-lag in addition to the quantity of an effect on anomalies of sensor signals.

### <Object-Equipment Models and Network of Selected Sensor Signals>

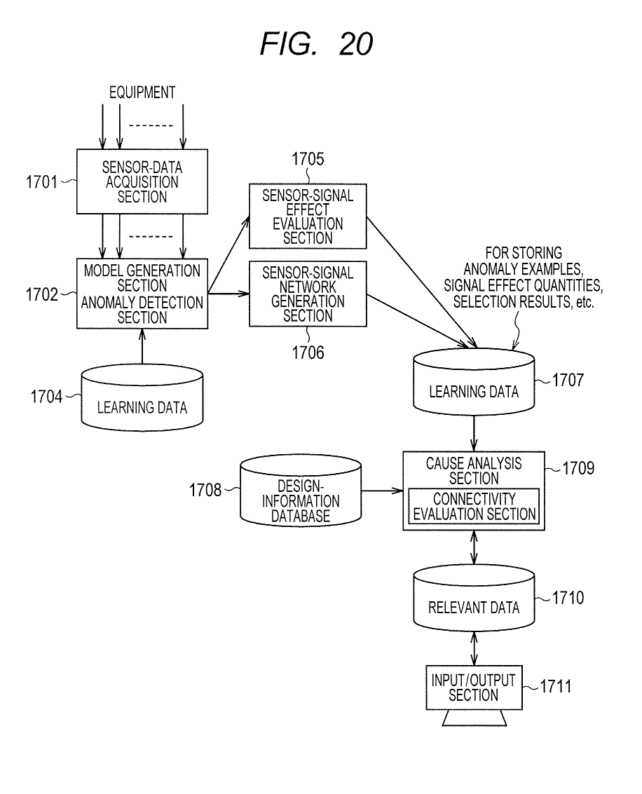

FIG. 20 shows the configurations of the anomaly detection portion and the cause diagnosis portion. As shown in FIG. 20, the configurations comprise a sensor-data acquisition section 1701 (corresponding to the multi-dimensional time-series signal acquisition section 103 shown in FIG. 1) for acquiring data from a plurality of sensors, learning data 1704 composed of all but normal data, a model generation section 1702 for converting the learning data into a model, an anomaly detection section 1703 for detecting the existence/non-existence of an anomaly in observation data on the basis of similarity between the observation data and the modeled learning data, a sensor-signal effect-quantity evaluation section 1705 for evaluating the quantity of an effect on sensor signals, a sensor-signal network generation section 1706 for creating a network diagram representing relevance between sensor signals, a learning-data database 1707 used for storing information such as anomaly examples, the quantity of an effect on every sensor signal and selection results, a design-information database 1708 used for storing information on designs of pieces of equipment, a cause diagnosis section 1709, a relevance database 1710 used for storing diagnosis results and an input/output section 1711. A keyword obtained as a result of execution of these kinds of processing in the configurations described above is also used in the diagnosis models explained earlier by referring to FIGS. 4A to 4E. In other words, these kinds of processing carried out in the configurations described above can also be perceived as a keyword generation section.

The design-information database is also used for storing information other than the design information. In the case of an engine, for example, the information stored in the design-information database 1708 includes a model year, a model, a table of parts (BOM), past maintenance information, information on operating conditions and inspection data obtained at the transport/installation time. (The past maintenance information includes an on-call description, sensor-signal data obtained in the event of a generated anomaly, an adjustment date/time, taken-image data, abnormal-noise information and information on replacement parts to mention a few).

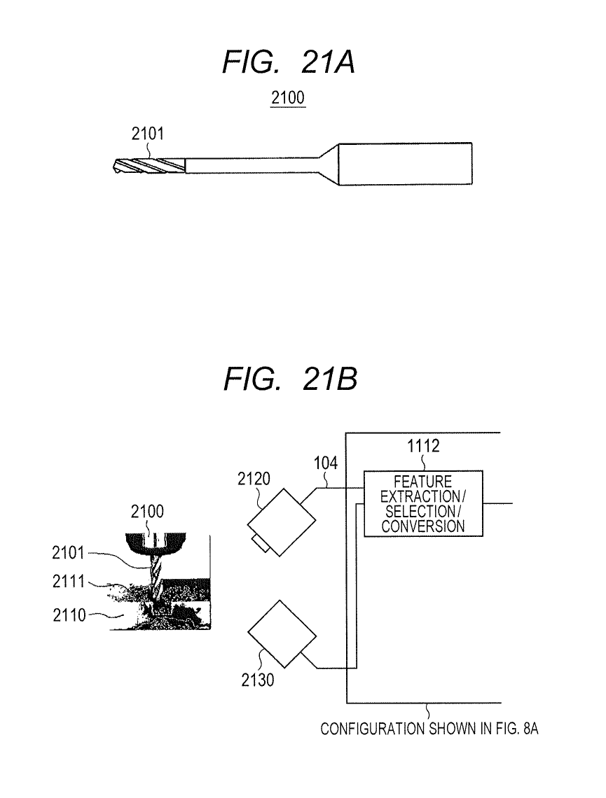

Finally, FIGS. 21A and 21B show other typical objects. To be more specific, FIG. 21A shows the external view of a drill 2100 for a hole boring manufacturing process. The left-hand side shows a blade end 2101. On the other hand, FIG. 21B shows a state in which a sample 2110 is being manufactured by making use of the drill 2100. While the sample 2110 is being manufactured, a defect may be generated on the blade end 2101 of the drill 2100. Thus, management of the state is important. In order to manage the state, a power signal is obtained from a servo amplifier of a motor for the hole boring manufacturing process in order to detect the existence of a defect on the blade end 2101 from the waveform of the power signal. (The servo amplifier and the motor are not shown in the figure). The method for detecting a defect is the method described earlier by referring to FIG. 8A. As an alternative, a vibration measurement sensor is attached to this drill 2100 in order to generate a high-order multi-dimensional sensor signal. In this way, the sensitivity of the detection can be further improved. As another alternative, while the manufacturing process is being carried out to bore a hole, sounds are picked up by a microphone 2130 and a sound signal is used as an object in the detection of a defect. As feature transformation, a kind of Fourier transform is appropriate.

In addition, in order to detect an anomaly sign, an image is taken by making use of a camera 2120 and the external view of the blade end 2101 is checked. The external view can be checked for every hole boring process or checked after a predetermined number of holes have been bored.

It is to be noted that, as shown in FIG. 21B, an image produced by the camera 2120 can be detected as an object for recognizing how chips 2111 are output from the sample 2110 used as an object of the process of boring a hole. In this case, with the image taken as an object, the method explained earlier by referring to FIG. 8A can also be used for detecting an anomaly.

In addition to the drill, a cutter or the like can be used as an object of detection of an anomaly generated at the blade end thereof. On top of that, the degree of opening of a hole bored on the product serving as a hole boring manufacturing process can also be observed by making use of the camera 2010.

### INDUSTRIAL APPLICABILITY

The present invention can be applied to detection of an anomaly of a plant or equipment.

### REFERENCE SIGN LIST

100 . . . anomaly prediction/diagnostic system
103 . . . Multi-dimensional time-series signal acquisition section
120 . . . Processor
121 . . . Database section
122 . . . Display section
123 . . . Input section

1. An anomaly detection/diagnostic method used for detecting an anomaly of a plant or equipment or detecting an anomaly sign of said plant or said equipment and used for diagnosing said plant or said equipment, said anomaly detection/diagnostic method comprising:
detecting an anomaly of said plant or said equipment or detecting an anomaly sign of said plant or said equipment by taking sensor data acquired from a plurality of sensors installed in said plant or said equipment and/or operating data such as operation times and operating times as an object;
associating said anomaly of said plant or said equipment or said anomaly sign of said plant or said equipment with past countermeasures by making use of maintenance-history information of said plant or said equipment; and
classifying and presenting said anomaly requiring a countermeasure or said anomaly sign requiring a countermeasure on the basis of results of said association.

2. The anomaly detection/diagnostic method according to claim 1, wherein:
said maintenance-history information includes at least some of on-call data, work reports, adjustments/replacement part codes, video information and audio information;
an appearance frequency of a keyword determined from said maintenance-history information, the number of combinations with other keywords and a combination frequency are computed in order to obtain a pattern of a high appearance frequency;
said obtained pattern of said high appearance frequency is taken as a category;
said sensor data and said operating data of said anomaly detected at said plant or said equipment or said anomaly sign detected at said plant or said equipment are classified; and
on the basis of results of said classification, said anomaly requiring a countermeasure or said anomaly sign requiring a countermeasure is classified and presented.

3. The anomaly detection/diagnostic method according to claim 1, wherein:
operating data of said plant or operating data of said equipment is acquired;
sensor data is acquired from said sensors;
data included in said acquired sensor data and/or said acquired operating data as data composed of almost normal data is modeled as learning data;
said modeled learning data is used to compute an anomaly measure of said acquired sensor data and/or said acquired operating data as a vector; and
an anomaly of said plant or said equipment is detected on the basis of the magnitude of said computed anomaly measure vector or the angle of said vector.

4. The anomaly detection/diagnostic method according to claim 1, wherein:
said operating data is used to calibrate said acquired sensor data;
data included in said calibrated sensor data as data composed of almost normal data is modeled as learning data;
said modeled learning data is used to compute anomaly measure of said calibrated sensor data as a vector; and
an anomaly of said plant or said equipment is detected on the basis of the magnitude of said computed anomaly measure vector or the angle of said vector.

5. The anomaly detection/diagnostic method according to claim 1, further comprising
computing the success rate for a requested countermeasure proposal on the basis of a result of a countermeasure,
wherein sensitivity for an anomaly sign can be adjusted on the basis of said computed success rate.

6. The anomaly detection/diagnostic method according to claim 1, further comprising
generating and outputting equipment records.

7. An anomaly detection/diagnostic method used for detecting an anomaly of a plant or equipment or detecting an anomaly sign of said plant or said equipment and used for diagnosing said plant or said equipment, said anomaly detection/diagnostic method comprising:
detecting an anomaly of said plant or said equipment or detecting an anomaly sign of said plant or said equipment by taking sensor data acquired from a plurality of sensors installed in said plant or said equipment and/or operating data such as operation times and operating times as an object; and
carrying out state monitoring by making use of an image obtained from an image taking operation as an object.

8. An anomaly detection/diagnostic system used for detecting an anomaly of a plant or equipment or detecting an anomaly sign of said plant or said equipment and used for diagnosing said plant or said equipment, said anomaly detection/diagnostic system comprising:
an anomaly detection section for detecting an anomaly of said plant or said equipment or an anomaly sign of said plant or said equipment by taking sensor data acquired from a plurality of sensors installed in said plant or said equipment and/or operating data such as operation times and operating times as an object;
a database section for storing maintenance-history information comprising information such as countermeasures for said plant or said equipment; and
a diagnostic section for associating an anomaly detected by said anomaly detection section as an anomaly of said plant or said equipment or an anomaly sign detected by said anomaly detection section as an anomaly sign of said plant or said equipment with past countermeasures by making use of information stored in said database section to serve as maintenance-history information of said plant or said equipment and for classifying and presenting an anomaly requiring a countermeasure or an anomaly sign requiring a countermeasure on the basis of results of said association.

9. The anomaly detection/diagnostic system according to claim 8, wherein:
said maintenance-history information stored in said database section includes at least some of on-call data, work reports, adjustments/replacement part codes, video information and audio information;
said diagnosis-model generation section computes an appearance frequency of a keyword determined from said maintenance-history information, the number of combinations with other keywords and a combination frequency in order to obtain a pattern of a high appearance frequency;
said obtained pattern of said high appearance frequency is taken as a category;
said sensor data and said operating data of said anomaly detected at said plant or said equipment or said anomaly sign detected at said plant or said equipment are classified; and
on the basis of results of said classification, said anomaly requiring a countermeasure or said anomaly sign requiring a countermeasure is classified and presented.

10. The anomaly detection/diagnostic system according to claim 8, wherein said diagnosis-model generation section:
acquires operating data of said plant or operating data of said equipment and sensor data from said sensors installed in said plant or said equipment;
models data included in said acquired sensor data and/or said acquired operating data as data composed of almost normal data as learning data;
makes use of said modeled learning data in order to compute an anomaly measure of said sensor data acquired from said sensors or an anomaly measure of said operating data of said plant or said equipment as a vector; and
detects an anomaly of said plant or said equipment on the basis of the magnitude of said computed anomaly measure vector or the angle of said vector.

11. The anomaly detection/diagnostic system according to claim 8, wherein said diagnosis-model generation section:
makes use of said operating data to calibrate said acquired sensor data;
models data included in said calibrated sensor data as data composed of almost normal data as learning data;
makes use of said modeled learning data to compute an anomaly measure of said calibrated sensor data as a vector; and
detects an anomaly of said plant or said equipment on the basis of the magnitude of said computed anomaly measure vector or the angle of said vector.

12. The anomaly detection/diagnostic system according to claim 11, wherein said diagnosis-model generation section:
makes use of said operating data to calibrate said acquired sensor data;
models a data group comprising data included in said calibrated sensor data and data of other plants and other equipment as data composed of almost normal data as learning data;
makes use of said modeled learning data to compute an anomaly measure of said calibrated sensor data as a vector; and
detects an anomaly of said plant or said equipment on the basis of the magnitude of said computed anomaly measure vector or the angle of said vector.

13. The anomaly detection/diagnostic system according to claim 8, further comprising:
a countermeasure-proposal presenting section for presenting a countermeasure proposal; and
an success rate evaluation section for computing the success rate of said presented countermeasure proposal on the basis of a countermeasure result,
wherein sensitivity for an anomaly sign can be adjusted on the basis of a success rate computed by said success rate evaluation section.

14. An anomaly detection/diagnostic system used for detecting an anomaly of a plant or equipment or detecting an anomaly sign of said plant or said equipment and used for diagnosing said plant or said equipment, said anomaly detection/diagnostic system comprising:
an anomaly detection section for detecting an anomaly of said plant or said equipment or an anomaly sign of said plant or said equipment by taking sensor data acquired from a plurality of sensors installed in said plant or said equipment and/or operating data such as operation times and operating times as an object;
a diagnostic section for associating an anomaly of said plant or said equipment or an anomaly sign of said plant or said equipment with past countermeasures by making use of maintenance-history information of said plant or said equipment and for classifying and presenting an anomaly requiring a countermeasure or an anomaly sign requiring a countermeasure on the basis of results of said association; and
a record generation section for generating records of said equipment.
